(19) United States
(12) Patent Application Publication
(10) Pub. No.: US 2022/0207539 A1
(43) Pub. Date: Jun. 30, 2022

(54) SYSTEM AND METHOD FOR PREDICTING A FIT QUALITY FOR A HEAD WEARABLE DEVICE AND USES THEREOF

(71) Applicant: JAND, INC., New York, NY (US)

(72) Inventors: Sasha Laundy, Culver City, CA (US); Taylor Alexandra Duffy, Midland Park, NJ (US); David Howard Goldberg, New York, NY (US); Maxwell Shron, Ossining, NY (US); Benjamin Jacob Cohen, New York, NY (US)

(73) Assignee: JAND, INC., New York, NY (US)

(21) Appl. No.: 17/134,163

(22) Filed: Dec. 24, 2020

(51) Int. Cl. G06Q 30/02; G06T 7/55; G06T 7/73; G06T 7/20; G06T 7/30; G06F 16/245

(52) U.S. Cl. CPC G06Q 30/0201; G06T 7/55; G06T 7/74; G06T 7/20; G06T 2207/30196; G06F 16/245; G06T 2207/10028; G06T 2207/20212; G06T 7/30

(57) ABSTRACT

A system having at least one processor and at least one memory for predicting a fit quality between a wearable device and one or more customers is disclosed. The system comprises: a user interface generator configured for receiving a request from a user; a population engine configured for generating, based on the request, simulated head data based on real head data of a sample of customers; and a fit engine configured for determining fit information between the simulated head data and at least one design of the wearable device, wherein the fit information is displayed to the user as a response to the request. Methods and uses thereof are also disclosed.

### FIELD

The disclosure herein generally relates to the technical field of head wearable devices. More specifically, the disclosure herein is directed to systems and methods for predicting a fit quality between a wearable device (which includes, but not limited to, spectacles, 3D glasses, augmented reality glasses, virtual reality glasses or headset, smart glasses, sports glasses, safety glasses, or a combination thereof) and customers (potential and/or actual), and uses thereof.

### BACKGROUND

The following includes information that may be useful in understanding the invention. It is not an admission that any of the information specifically or implicitly referenced herein is prior art, or essential, to the described or claimed invention. All patents, patent applications, publications and products mentioned herein are hereby incorporated by reference in their entirety.

Presently, companies use a generic, rudimentary process to design head wearable devices, such as spectacles, in different sizes, and choose an assortment of head wearable devices (“assorting”) that can serve as many customers as possible. Such companies use default head wearable device sizes, e.g., default frame dimensions, provided by their factories and test new sizes by putting head wearable device samples on a trial group comprising a small number of individuals. After launch, assortment performance analysis is based on anecdotes from retail staff and general summary statistics of sales data for existing products and sizes. This current method has several limitations. First, sales data does not provide any insight into what is not working for people who cannot find a head wearable device, such as spectacles. One hypothesis is that there is one or more groups of people who cannot find a head wearable device that fit correctly, and therefore do not purchase. Second, expanding a sizing system according to the existing method means simply scaling the head wearable devices bigger or smaller based on generally-established ratios, rather than responding to a realistic distribution of human head sizes and shapes. Third, customers rarely have a clear sense of what a “good fit” looks like for head wearable devices like spectacles, which makes customer feedback data difficult to interpret and how it could be applied generally across one or more subgroups within the customer population.

Certain eyewear companies provide custom-fit head wearable device, such as spectacles, to each customer. However, this approach requires taking estimated fit measurements, via 3D scans, for each customer to provide a custom-fit head wearable device, such as spectacles. Such 3D scans attempt to tackle fit concepts that are very complex to describe and execute, and may not provide a fit that is suitable for the customer. This approach is also expensive and time-consuming to implement and manufacture since each device is bespoke and made-to-order, which decreases affordability for such custom-fit head wearable device.

Hence, there is a need for improved, cost-effective methods for developing new size categories for head wearable devices, such as spectacles, that result in intelligent mass production and assorting while generating better fit and promoting affordability.

### SUMMARY

The invention described and claimed herein has many attributes and aspects including, but not limited to, those set forth or described or referenced in this Summary. It is not intended to be all-inclusive and the invention described and claimed herein are not limited to or by the features or embodiments identified in this Summary, which is included for purposes of illustration only and not restriction. In various embodiments of the disclosure herein, systems and methods are provided for predicting a fit quality between a head wearable device, such as spectacles, and customers (potential and/or actual).

In one example, a system having at least one processor and at least one memory for predicting a fit quality between a wearable device (such as a head wearable device) and one or more customers is disclosed. The system comprises a user interface generator configured for receiving a request from a user; a population engine configured for generating, based on the request, simulated head data based on real head data of a sample of customers, non-customers, or a combination thereof; and a fit engine configured for determining fit information between the simulated head data and at least one design of the wearable device, wherein the fit information is displayed to the user as a response to the request. A “customer” can be a potential customer, an actual customer, or a combination thereof. Customer, non-customer, or a subject can be human, male, female, non-binary, agender, gender nonconforming, cisgender, transgender, gender fluid, intersex, bigender, genderqueer, other gender(s), adult (at least 18 years of age), child (from birth to 17 years of age), or a combination thereof. The customer or subject can also be in one or more race and/or ethnic groups (e.g., one or more race and/or ethnic groups originating in/from Africa (includes, but limited to, Northern Africa, Sub-Saharan Africa, Eastern Africa, Middle Africa, Southern Africa and Western Africa); Asia (includes, but limited to, Central Asia, Eastern Asia, Southeast Asia, Southern Asia, and Western Asia); Caribbean; Central America; Europe (includes, but limited to, Eastern Europe, Northern Europe, Southern Europe, and Western Europe); India; the Middle East; North America; Oceania (includes, but limited to, Australasia, Melanesia, Micronesia and Polynesia); and South America; White, Black, African American, American Indian, Alaska Native, Asian, Native Hawaiian, Pacific Islander, Hispanic, Latinx and other race/ethnic groups). The customer or subject can also be in one or more age groups (e.g., birth to 17 years old; birth to 5 years old; 6 years old to 12 years old; 13 years old to 17 years old; at least 18 years old; 18 years old to 29 years old; 30 years old to 39 years old; 40 years old to 49 years old; 50 years old to 59 years old; 60 years old to 69 years old; 70 years old to 79 years old; 80 years old to 89 years old; 90 years old to 99 years old; at least 100 years old), or a specific age from birth to 150 years old (e.g., 8 years old; 18 years old; 35 years old; 45 years old; 55 years old; 65 years old; 75 years old; 85 years old; 95 years old; and 105 years old). The customer or subject can also have one or more facial and/or craniofacial features, which includes, but limited to, a boxers' nose deformity/saddle nose deformity, ocular hypertelorism, ocular hyporteloris, hypoplastic nasal bone, or flat nasal bridge. A “head wearable device” or “wearable device” (which can be used interchangeably) includes, but not limited to, monocles, spectacles, 3D glasses (e.g., passive 3D glasses, which includes, but not limited to, anaglyph 3D glasses, super-anaglyph 3D glasses and polarized 3D glasses; active 3D glasses, which includes, but not limited to, active-shutter 3D glasses), augmented reality glasses, virtual reality glasses or headset, smart glasses, sports glasses, safety glasses, or a combination thereof.

In another example, a method, implemented on a computing device having at least one processor and at least one memory for predicting a fit quality between a wearable device and one or more customers, is disclosed. The method comprises receiving a request from a user; generating, based on the request, simulated head data based on real head data of a sample of subjects; determining fit information between the simulated head data and at least one design of the wearable device; and providing the fit information to the user as a response to the request.

Other concepts relate to software for implementing the disclosure herein on predicting a fit quality for a wearable device. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, a non-transitory computer readable medium having computer-executable instructions embodied thereon for predicting a fit quality between a wearable device and one or more customers is disclosed. When executed by a processor, the computer-executable instructions cause the processor to perform: receiving a request from a user; generating, based on the request, simulated head data based on real head data of a sample of subjects; and determining fit information between the simulated head data and at least one design of the wearable device, wherein the fit information is displayed to the user as a response to the request.

Additional novel features will be set forth in part in the description which follows, and in part will become apparent to those skilled in the art upon examination of the following and the accompanying drawings or may be learned by production or operation of the examples. The novel features of the disclosure herein may be realized and attained by practice or use of various aspects of the methodologies, instrumentalities and combinations set forth in the detailed example s discussed below.

### BRIEF DESCRIPTION OF THE FIGURES

The accompanying drawings, which are incorporated herein and form a part of the specification, illustrate the aspects of the disclosure herein and, together with the description, further serve to explain the principles of the aspects and to enable a person skilled in the pertinent art to make and use the aspects. The drawings are for illustration purposes only, show exemplary non-limiting embodiments, and are not necessarily drawn to scale.

FIG. 1A illustrates a high level depiction of an exemplary networked environment for predicting a fit quality for a wearable device, in accordance with some embodiments of the disclosure herein.

FIG. 1B illustrates one example of an architecture of a client device, in accordance with some embodiments of the disclosure herein.

FIG. 2 illustrates a high level depiction of another exemplary networked environment for predicting a fit quality for a wearable device, in accordance with some embodiments of the disclosure herein.

FIG. 3 illustrates an exemplary diagram of a fit prediction system and its relationship with one or more fit prediction related databases, in accordance with some embodiments of the disclosure herein.

FIG. 4 is a flowchart of an exemplary process performed by a fit prediction system, in accordance with some embodiments of the disclosure herein.

FIG. 5 illustrates an exemplary diagram of a user interface generator, in accordance with some embodiments of the disclosure herein.

FIG. 6 is a flowchart of an exemplary process performed by a user interface generator, in accordance with some embodiments of the disclosure herein.

FIG. 7 illustrates an exemplary diagram of a population engine, in accordance with some embodiments of the disclosure herein.

FIG. 8 is a flowchart of an exemplary process performed by a population engine, in accordance with some embodiments of the disclosure herein.

FIG. 9 illustrates an exemplary diagram of a fit engine, in accordance with some embodiments of the disclosure herein.

FIG. 10 is a flowchart of an exemplary process performed by a fit engine, in accordance with some embodiments of the disclosure herein.

FIG. 11 illustrates an exemplary diagram of a fit rule generator, in accordance with some embodiments of the disclosure herein.

FIG. 12 is a flowchart of an exemplary process performed by a fit rule generator, in accordance with some embodiments of the disclosure herein.

FIG. 13 illustrates an exemplary diagram of a three-dimensional (3D) scanner, in accordance with some embodiments of the disclosure herein.

FIG. 14 is a flowchart of an exemplary process performed by a 3D scanner, in accordance with some embodiments of the disclosure herein.

### DETAILED DESCRIPTION

This description of the exemplary embodiments is intended to be read in connection with the accompanying drawings, which are to be considered part of the entire written description. The use of the singular includes the plural unless specifically stated otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

The following description is provided as an enabling teaching of a representative set of examples. Many changes can be made to the embodiments described herein while still obtaining beneficial results. Some of the desired benefits discussed below can be obtained by selecting some of the features discussed herein without utilising other features. Accordingly, many modifications and adaptations, as well as subsets of the features described herein are possible and can even be desirable in certain circumstances. Thus, the following description is provided as illustrative and is not limiting.

As used herein, use of a singular article such as “a,” “an” and “the” is not intended to exclude pluralities of the article's object unless the context clearly and unambiguously dictates otherwise.

While spectacles or eyeglasses are used as examples in the following disclosure, the methods and systems in the disclosure herein can be applied to any wearable device or head wearable device whose size and shape may be adjusted to improve a fit to different populations.

The terms “spectacles,” “eyeglasses” and “glasses” may be used interchangeably herein when referring to a wearable device for fit prediction. The terms “head” and “face” may be used interchangeably herein when referring to head data used for fit prediction. The term “frame” refers to a frame of a pair of eyeglasses, sunglasses, glasses, or goggles, etc.

The disclosure herein provides methods and systems for designing and/or testing new shapes and sizes of a head wearable device, e.g., a pair of spectacles, on one or more populations, without a need of any physical wearable device or live models. This allows faster iteration on individual head wearable device design and supports inventory purchases in new sizes and size categories that cover a broader range of customers.

A method disclosed in the disclosure herein can find simple new size categories and intelligently make larger inventory purchases, such that more individuals can get a better fit while preserving affordability. In some embodiments, an interface is provided to a specially designed fit engine. The user interface enables an end user to create an assortment of spectacles (any number, real or hypothetical), select their target population, and get immediate detailed feedback. A target population may be, e.g., an individual person, a population segment like “widest 10th percentile of men,” demographic breakdowns of a country, city, state, neighborhood, etc. A detailed feedback may include information related to: e.g., which frames will fit the most people? Will a new extra narrow size design fit the narrowest portion of the population? How many people cannot find a good fit and need new sizes? In case of misfits, what is the key cause to design around?

The methods and systems in the disclosure herein can be applied by any eyewear design company, including manufacturers of, for examples, prescription glasses, virtual reality or augmented reality eyewear/glasses, sports eyewear/glasses, and safety eyewear/glasses. One application of the disclosed system is a hypothetical clearinghouse that helps customers to find eyewear brands that make spectacles fitting them. Because many eyewear brands use the same rules of thumb (such as set size ratios between eye size, bridge size, and temple length) to design sizes, if a customer does not fit sizes from one brand, the customer is likely not to fit sizes from any brand. In this case, a clearinghouse can help those customers to find: e.g., very narrow frames, the best low bridge fit frames that are also very wide, frames that are particularly good for progressive lenses, etc.

Another application of the disclosed system is a tool enabling an automatic optician adjustment of spectacles in the lab before sending to a customer. For example, after customers order eyeglasses, based on the head depth measurements, temple arms of one or more lengths mostly likely to fit or that fits property on the customer are attached to the frame, and/or the temple arms attached to the frame are adjusted via bending one or more temple arms to accommodate customers' head sizes. If, for example, a customer has a narrow pupillary distance (PD) but a wide skull, the one or more temple arms may be adjusted to splay to fit the customer right out of the box. This feature is especially helpful for people with limited mobility and/or are immunocompromised, people in areas affected by stay-at-home quarantines, pandemics or riots who may not want to or cannot visit stores in person, or people who live far away from a store who can adjust their frames.

Additional novel features will be set forth in part in the description which follows, and in part will become apparent to those skilled in the art upon examination of the following and the accompanying drawings or may be learned by production or operation of the examples. The novel features of the disclosure herein may be realized and attained by practice or use of various aspects of the methodologies, instrumentalities and combinations set forth in the detailed example s discussed below.

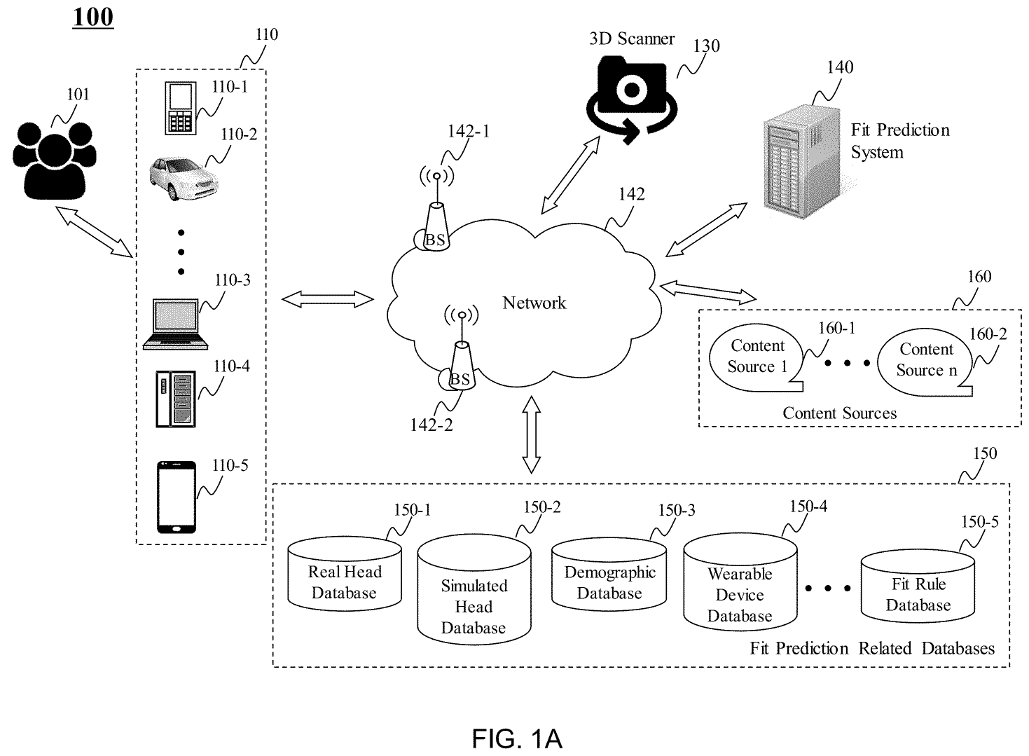

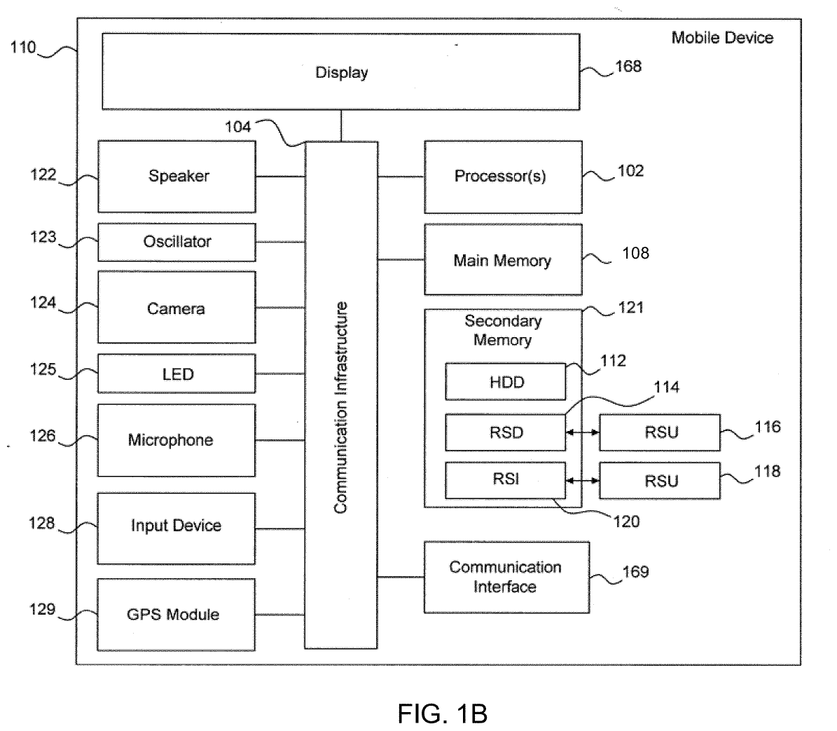

FIG. 1A is a high level depiction of an exemplary networked environment 100 for predicting a fit quality for a head wearable device, according to an embodiment of the disclosure herein. In FIG. 1A, the exemplary networked environment 100 includes one or more users 101, a network 142, a three-dimensional (3D) scanner 130, a fit prediction system 140, fit prediction related databases 150, and content sources 160. The network 142 may be a single network or a combination of different networks. For example, the network 142 may be a local area network (LAN), a wide area network (WAN), a public network, a private network, a proprietary network, a Public Telephone Switched Network (PSTN), the Internet, a wireless network, a virtual network, or any combination thereof. The network 142 may also include various network access points, e.g., wired or wireless access points such as base stations or Internet exchange points 142-1 . . . 142-2, through which a data source may connect to the network 142 in order to transmit information via the network 142.

Users 101 may connect to the network 142 via any of a plurality of client devices: e.g., a mobile device 110-1, a built-in device in a motor vehicle 110-2, laptop computers 110-3, desktop computers 110-4, and smartphones 110-5 (collectively “client devices 110”). In one embodiment, users 101 may be connected to the network 142 and able to interact with the 3D scanner 130 and/or the fit prediction system 140 through wired or wireless technologies and related operating systems implemented within user-wearable devices (e.g., smart eyeglasses, wrist watch, etc.).

A user may send, via, for example, the client device 110-1, a request to the fit prediction system 140 through the network 142 and receive a response from the fit prediction system 140. The request may be related to predicting a fit quality and nature of a wearable device design based on customer head data. For example, when a user has an inventory of eyeglasses and wants to sell them to a target group of people, the user may be interested in fit information between the eyeglasses and the target group of people. Based on a request from the user, the fit prediction system 140 may generate a fit probability for each head-design data pair, where each data pair represents a pair of data comprising a head data of a person and a design data (e.g., size and/or shape) of spectacles. While the fit probability is low, the fit prediction system 140 may also generate a reason of the low fit or misfit.

In another example, a user has an inventory of eyeglasses and wants to find a target population to sell the eyeglasses. Based on a request from the user, the fit prediction system 140 may generate simulated population data which can fit the design of the eyeglasses with a fit probability larger or smaller than a predetermined threshold. The user can at least know demographic information of the target population based on the generated simulated population data.

In yet another example, a user wants to find eyeglasses that can fit a target population in a city, to sell the eyeglasses to the people in the city. Based on a request from the user, the fit prediction system 140 may generate eyeglass designs (e.g., size and/or shape) that will fit the people in the city with a fit probability larger or smaller than a predetermined threshold, based on real and/or simulated head data of the people in the city.

The 3D scanner 130 and the fit prediction system 140 may access information stored in the fit prediction related databases 150 via the network 142. The information in each of the fit prediction related databases 150 (e.g., the real head database 150-1, the simulated head database 150-2, the demographic database 150-3, the wearable device database 150-4, the fit rule database 150-5, etc.) may be generated by one or more different applications, which may be running on the 3D scanner 130, the fit prediction system 140, or as a completely standalone system capable of connecting to the network 142, accessing information from different sources, analyzing the information, generating structured information, and storing such generated information in the database. For example, the 3D scanner 130 may perform a 3D scan of a person's head and store the real head data into the real head database 150-1.

The content sources 160 in the exemplary networked environment 100 include multiple content sources 160-1 . . . 160-2. A content source 160 may correspond to a website or app hosted by an entity, whether an individual, a business, or an organization such as USPTO.gov, a content provider such as cnn.com, nytimes.com, npr.org, huffpost.com, usatoday.com, wsj.com and Yahoo.com, a social network site such as Facebook, YouTube, WhatsApp, Messenger, WeChat, Instagram or Line, or a content feed source such as tweets from Twitter or blogs. The fit prediction system 140 may access information from any of the content sources 160-1 . . . 160-2. For example, the fit prediction system 140 may fetch content, e.g., websites, to obtain some public demographic statistics of a city.

In various embodiments, client devices 110 include any mobile device capable of transmitting and receiving wireless signals. Examples of mobile instruments include, but are not limited to, mobile or cellular phones, smart phones, personal digital assistants (“PDAs”), laptop computers, tablet computers, music players, and e-readers, to name a few possible devices.

FIG. 1B is a block diagram of one example of an architecture of client device 110. As shown in FIG. 1B, client device 110 includes one or more processors, such as processor(s) 102. Processor(s) 102 may be any central processing unit (“CPU”), microprocessor, micro-controller, or computational device or circuit for executing instructions. Processor(s) are connected to a communication infrastructure 104 (e.g., a communications bus, cross-over bar, or network). Various software embodiments are described in terms of this exemplary client device 110. After reading this description, it will be apparent to one of ordinary skill in the art how to implement the method using client devices 110 that include other systems or architectures. One of ordinary skill in the art will understand that computers 110-3, 110-4 may have a similar and/or identical architecture as that of client devices 110 shown in FIG. 1B. Put another way, computers 110-3, 110-4 can include some, all, or additional functional components as those of the client device 110 illustrated in FIG. 1B.

Client device 110 includes a display 168 that displays graphics, video, text, and other data received from the communication infrastructure 104 (or from a frame buffer not shown) to a user (e.g., a subscriber, commercial user, back-end user, or other user). Examples of such displays 168 include, but are not limited to, LCD screens, OLED display, capacitive touch screen, and a plasma display, to list only a few possible displays. Client device 110 also includes a main memory 108, such as a random access (“RAM”) memory, and may also include a secondary memory 110. Secondary memory 121 may include a more persistent memory such as, for example, a hard disk drive (“HDD”) 112 and/or removable storage drive (“RSD”) 114, representing a magnetic tape drive, an optical disk drive, solid state drive (“SSD”), or the like. In some embodiments, removable storage drive 114 reads from and/or writes to a removable storage unit (“RSU”) 116 in a manner that is understood by one of ordinary skill in the art. Removable storage unit 116 represents a magnetic tape, optical disk, or the like, which may be read by and written to by removable storage drive 114. As will be understood by one of ordinary skill in the art, the removable storage unit 116 may include a tangible and non-transient machine readable storage medium having stored therein computer software and/or data.

In some embodiments, secondary memory 110 may include other devices for allowing computer programs or other instructions to be loaded into client device 110. Such devices may include, for example, a removable storage unit (“RSU”) 118 and a corresponding interface (“RSP”) 120. Examples of such units 118 and interfaces 120 may include a removable memory chip (such as an erasable programmable read only memory (“EPROM”)), programmable read only memory (“PROM”)), secure digital (“SD”) card and associated socket, and other removable storage units 118 and interfaces 120, which allow software and data to be transferred from the removable storage unit 118 to client device 110.

Client device 110 may also include a speaker 122, an oscillator 123, a camera 124, a light emitting diode (“LED”) 125, a microphone 126, an input device 128, an accelerometer (not shown), and a global positioning system (“GPS”) module 129. Examples of camera 124 features include, but are not limited to optical image stabilisation (“OIS”), larger sensors, bright lenses, 4K video, optical zoom plus RAW images and HDR, “Bokeh mode” with multi lenses and multi-shot night modes. Camera 124 may comprise one or more lenses with different functions. By way of example, camera 124 may include an ultrawide sensor, telephoto sensor, time of flight sensor, macro sensor, megapixel (“MP”) sensor, and/or a depth sensor. Camera 124, as described herein, is not limited to a single camera. Camera 124 may include a camera system that includes multiple different types of cameras, sensors, etc. By way of example, Apple® released a TrueDepth® camera system that includes a 7 MP front-facing “selfie” camera, infrared emitter, infrared camera, proximity sensor, ambient light sensor, flood illuminator, and dot projector that cooperate to obtain depth map and associated image. In other words, camera 124 of client device 110 may have multiple sensors, cameras, emitters, or other associated components that work as a system to obtain image information for use by client device 110.

Examples of input device 128 include, but are not limited to, a keyboard, buttons, a trackball, or any other interface or device through which a user may input data. In some embodiment, input device 128 and display 168 are integrated into the same device. For example, display 168 and input device 128 may be touchscreen through which a user uses a finger, pen, and/or stylus to input data into client device 110.

Client device 110 also includes one or more communication interfaces 169, which allows software and data to be transferred between client device 110 and external devices such as, for example, another client device 110, a computer 110-3, 110-4 and other devices that may be locally or remotely connected to system 100. Examples of the one or more communication interfaces 169 may include, but are not limited to, a modem, a network interface (such as an Ethernet card or wireless card), a communications port, a Personal Computer Memory Card International Association (“PCMCIA”) slot and card, one or more Personal Component Interconnect (“PCI”) Express slot and cards, or any combination thereof. The one or more communication interfaces 169 may also include a wireless interface configured for short range communication, such as near field communication (“NFC”), Bluetooth, or other interface for communication via another wireless communication protocol. As briefly noted above, one of ordinary skill in the art will understand that computers 110-3, 110-4 and portions of system 100 may include some or all components of client device 110.

Software and data transferred via the one or more communications interfaces 169 are in the form of signals, which may be electronic, electromagnetic, optical, or other signals capable of being received by communications interfaces 169. These signals are provided to communications interface 169 via a communications path or channel. The channel may be implemented using wire or cable, fiber optics, a telephone line, a cellular link, a radio frequency (“RF”) link, or other communication channels.

In this application, the terms “non-transitory computer program medium” and “non-transitory computer readable medium” refer to media such as removable storage units 116, 118, or a hard disk installed in hard disk drive 112. These computer program products provide software to client device 110. Computer programs (also referred to as “computer control logic”) may be stored in main memory 108 and/or secondary memory 110. Computer programs may also be received via the one or more communications interfaces 169. Such computer programs, when executed by a processor(s) 102, enable the client device 110 to perform the features of the methods and systems discussed herein.

In various embodiments, as shown in FIGS. 1A & 1B, client device 110 may include a computing device such as a hashing computer, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (“OHMDs”)), an embedded computing device (e.g., in communication with a smart textile or electronic fabric), or any other suitable computing device configured to store data and software instructions, execute software instructions to perform operations, and/or display information on a display device. Client device 110 may be associated with one or more users (not shown). For example, a user operates client device 110, causing it to perform one or more operations in accordance with various embodiments.

Client device 110 includes one or more tangible, non-transitory memories that store data and/or software instructions, and one or more processors configured to execute software instructions. Client device 110 may include one or more display devices that display information to a user and one or more input devices (e.g., keypad, keyboard, touchscreen, voice activated control technologies, or any other suitable type of known input device) to allow the user to input information to the client device. Client device 110 processor(s) may be any central processing unit (“CPU”), microprocessor, micro-controller, or computational device or circuit for executing instructions. Processor(s) are connected to a communication infrastructure (e.g., a communications bus, cross-over bar, or network). Various software embodiments are described in terms of this exemplary client device 110. After reading this description, it will be apparent to one of ordinary skill in the art how to implement the method using client device 110 that include other systems or architectures. One of ordinary skill in the art will understand that computers may have a similar and/or identical architecture as that of client device 110. Put another way, computers can include some, all, or additional functional components as those of the client device 110 illustrated in FIGS. 1A & 1B.

Client device 110 also includes one or more communication interfaces 169, which allows software and data to be transferred between client device 110 and external devices such as, for example, another client device 110, and other devices that may be locally or remotely connected to client device 110. Examples of the one or more communication interfaces may include, but are not limited to, a modem, a network interface (e.g., communication interface 169, such as an Ethernet card or wireless card), a communications port, a PCMCIA slot and card, one or more PCI Express slot and cards, or any combination thereof. The one or more communication interfaces 169 may also include a wireless interface configured for short range communication, such as NFC, Bluetooth, or other interface for communication via another wireless communication protocol.

Software and data transferred via the one or more communications interfaces 169 are in the form of signals, which may be electronic, electromagnetic, optical, or other signals capable of being received by communications interfaces. These signals are provided to communications interface 169 via a communications path or channel. The channel may be implemented using wire or cable, fiber optics, a telephone line, a cellular link, a radio frequency (“RF”) link, or other communication channels.

In an embodiment where the system 100 or method is partially or entirely implemented using software, the software may be stored in a computer program product and loaded into client device 110 using removable storage drive, hard drive, and/or communications interface. The software, when executed by processor(s), causes the processor(s) to perform the functions of the method described herein. In another embodiment, the method is implemented primarily in hardware using, for example, hardware components such as application specific integrated circuits (“ASICs”). Implementation of the hardware state machine so as to perform the functions described herein will be understood by persons skilled in the art. In yet another embodiment, the method is implemented using a combination of both hardware and software.

Embodiments of the subject matter described in this specification can be implemented in a system 100 that includes a back end component, e.g., as a data server, or that includes a middleware component, e.g., an application server, or that includes a front end component (e.g., a client device 110) having a graphical user interface or a Web browser through which a user can interact with an implementation of the subject matter described is this specification, or any combination of one or more such back end, middleware, or front end components. The components of the system can be interconnected by any form or medium of digital data communication, (e.g., a communication network 142). Communications network 142 may include one or more communication networks or media of digital data communication. Examples of communication network 142 include a local area network (“LAN”), a wireless LAN, a RF network, a NFC network, (e.g., a “WiFi” network), a wireless Metropolitan Area Network (“MAN”) connecting multiple wireless LANs, NFC communication link(s), and a wide area network (“WAN”), e.g., the Internet and combinations thereof. In accordance with various embodiments of the disclosure herein, communications network 142 may include the Internet and any publicly accessible network or networks interconnected via one or more communication protocols, including, but not limited to, hypertext transfer protocol (“HTTP”) and HyperText Transfer Protocol Secured (“HTTPS”) and Secured Socket Layer/Transport Layer Security (“SSL/TLS”) and transmission control protocol/internet protocol (“TCP/IP”). Communications protocols in accordance with various embodiments also include protocols facilitating data transfer using radio frequency identification (“RFID”) communications and/or NFC. Moreover, communications network 142 may also include one or more mobile device networks, such as a GSM or LTE network or a PCS network, allowing a client device to send and receive data via applicable communications protocols, including those described herein.

A client device 110 and the fit prediction system 140 are generally remote from each other and typically interact through a communication network 142. The relationship of client device 110 and the fit prediction system 140 arises by virtue of computer programs running on the respective system components and having a client-server relationship to each other. System 100 may include a web/application server (not shown) in embodiments used to gain access to many services provided by the fit prediction system 140.

In one aspect, the client device 110 stores in memory one or more software applications that run on the client device and are executed by the one or more processors. In some instances, each client device stores software applications that, when executed by one or more processors, perform operations that establish communications with the fit prediction system 140 (e.g., across communication network 142 via communication interface 169) and that obtain, from the fit prediction system 140, information or data via the fit prediction related databases 150 in accordance with various embodiments.

In various embodiments, client device 110 may execute stored software application(s) to interact with the fit prediction system 140 via a network connection. The executed software applications may cause client device 110 to communicate information (e.g., facial measurements (e.g., PD), user profile information, etc.). As described below, executed software applications (s) may be configured to allow a user associated with client device 110 to obtain a PD measurement using camera 124. Stored software application(s) on client device 110 are configured to access webpages on the Internet or other suitable network based communication capable of interacting with communication network 142, as would be understood by one of ordinary skill in the art. For example, the fit prediction system 140 may provide information to stored software application(s) on client device 110 via communication network 142. In this example, client device 110 will display information provided by the fit prediction system 140 using a stored software application(s) graphical user interface display. In the example above, a respective user account may be associated with a developer, client user, or supervisor/monitoring authority as would be understood by one of ordinary skill in the art and described below.

According to various embodiments, system 100 includes fit prediction related databases 150 for managing and storing data, for example, facial measurement information (e.g., PD, etc.), user account authentication information, and other data maintained by the fit prediction system 140. The fit prediction related databases 150 may be communicatively coupled with various modules and engines (not illustrated).

It should be understood that various forms of data storage or repositories can be used in system 100 that may be accessed by a computing system, such as hard drives, tape drives, flash memory, random-access memory, read-only memory, EEPROM storage, in-memory databases like SAP HANA, and so on, as well as any combination thereof. Stored data may be formatted within data stores in one or more formats, such as flat text file storage, relational databases, non-relational databases, XML, comma-separated values, Microsoft Excel files, or any other format known to those of ordinary skill in the art, as well as any combination thereof as is appropriate for the particular use. Data stores may provide various forms of access to the stored data, such as by file system access, network access, a SQL protocol (e.g., ODBC), HTTP, FTP, NES, CIFS, and so on, as well as any combination thereof.

According to various embodiments, client device 110 is configured to access the fit prediction related databases 150 via the fit prediction system 140. In various embodiments, each of the fit prediction related databases 150 is configured to maintain a database schema. For example, a database schema may be arranged to maintain identifiers in columns within the real head database 150-1 associated with facial measurement. In this aspect, identifiers refer to specific information pertaining to the categories described above. A database schema within the fit prediction related databases 150 may be arranged or organized in any suitable manner within the system. Although the above-described examples identify categorical identifiers, any number of suitable identifiers may be used to maintain records associated with the system described herein. In addition, a database schema may contain additional categories and identifiers not described above for maintaining record data in system 100. The database can also provide statistics and marketing information associated with users of system 100.

The database schema described above advantageously organizes identifiers in a way that permits the system to operate more efficiently. In some embodiments, categories of identifiers in the database schema increase efficiency by grouping identifiers with an associated management model of the fit prediction system 140.

In various embodiments, the fit prediction system 140 includes computing components configured to store, maintain, and generate data and software instructions. For example, the fit prediction system 140 may include or have access to one or more processors, one or more servers and tangible, non-transitory memory devices (e.g., local data store (in addition to the fit prediction related databases 150)) for storing software or code for execution and/or additional data stores. Servers may include one or more computing devices configured to execute software instructions stored on to perform one or more processes in accordance with various embodiments. In some embodiments, the fit prediction related databases 150 includes a server that executes software instructions to perform operations that provide information to at least one other component of computing environment 100, for example providing data to another data store or to third party recipients (e.g., banking systems, third party vendors, information gathering institutions, etc.) through a network, such as a communication network 142.

The fit prediction system 140 may be configured to provide one or more websites, digital portals, or any other suitable service that is configured to perform various functions of the fit prediction system 140 components. In some embodiments, the fit prediction system 140 maintains application programming interfaces (“APIs”) through which the functionality and services provided by the fit prediction system 140 may be accessed through one or more application programs executed by a client device 110. In various embodiments, the fit prediction system 140 may provide information to software application(s) on client device 110 for display on a graphical user interface 168.

In some embodiments, the fit prediction system 140 provides information to client device 110 (e.g., through the API associated with the executed application program). Client device 110 presents portions of the information to corresponding users through a corresponding respective graphical user interface 168 or webpage.

In various embodiments, the fit prediction system 140 is configured to provide or receive information associated with services provided by the fit prediction system 140 to client device 110. For example, client device 110 may receive information via communication network 142, and store portions of the information in a locally accessible store device and/or network-accessible storage devices and data stores (e.g., cloud-based storage). For example, client device 110 executes stored instructions (e.g., an application program, a web browser, and/or a mobile application) to process portions of stored data and render portions of the stored data for presentation to the respective user or users. The fit prediction system 140 may include additional servers (not shown) which may be incorporated as a corresponding node in a distributed network or as a corresponding networked server in a cloud-computing environment. Furthermore, servers may communicate via communication network 142 with one or more additional servers (not shown), that may facilitate the distribution of processes for parallel execution by the additional servers.

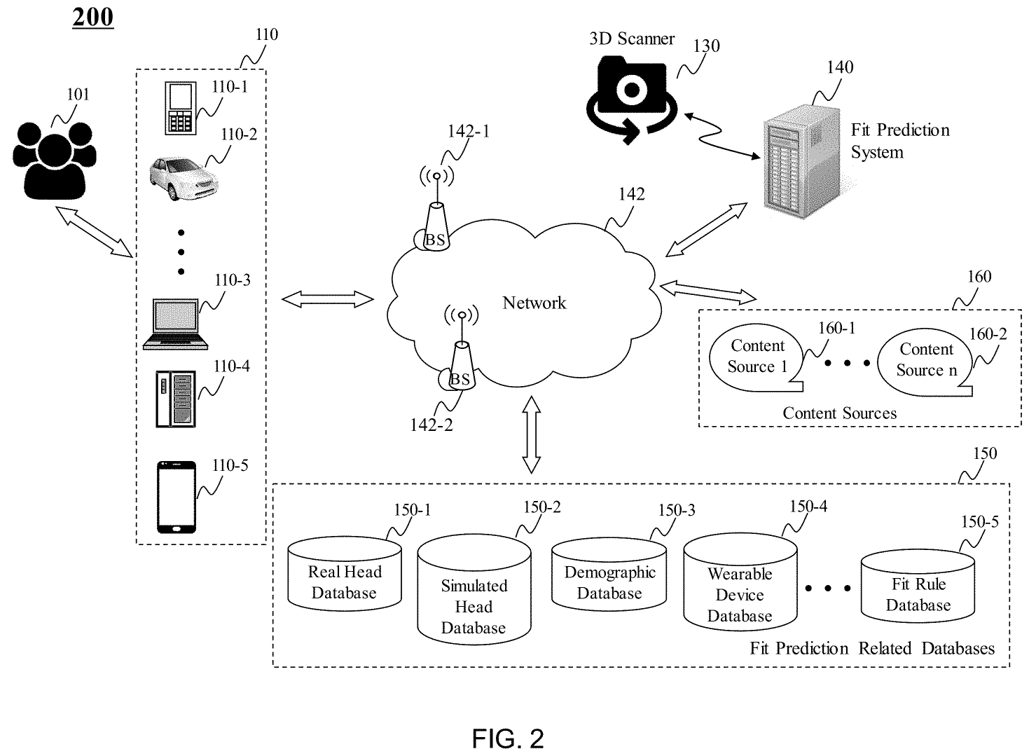

FIG. 2 is a high level depiction of another exemplary networked environment 200 for predicting a fit quality for a head wearable device, according to an embodiment of the disclosure herein. The exemplary networked environment 200 in this embodiment is similar to the exemplary networked environment 100 in FIG. 1, except that the 3D scanner 130 serves as a backend system for the fit prediction system 140, which can trigger operation of the 3D scanner 130, e.g. based on a request from a user.

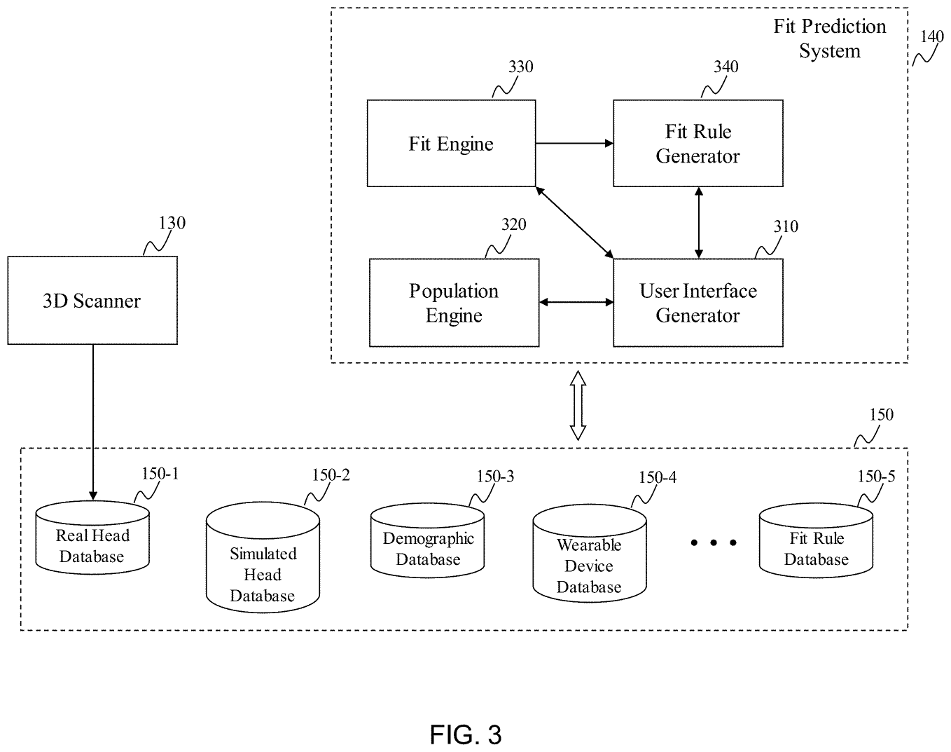

FIG. 3 illustrates an exemplary diagram of a fit prediction system 140 and its relationship with the fit prediction related databases 150, in accordance with some embodiments of the disclosure herein. The fit prediction system 140 in this example includes a user interface generator 310, a population engine 320, a fit engine 330, and a fit rule generator 340.

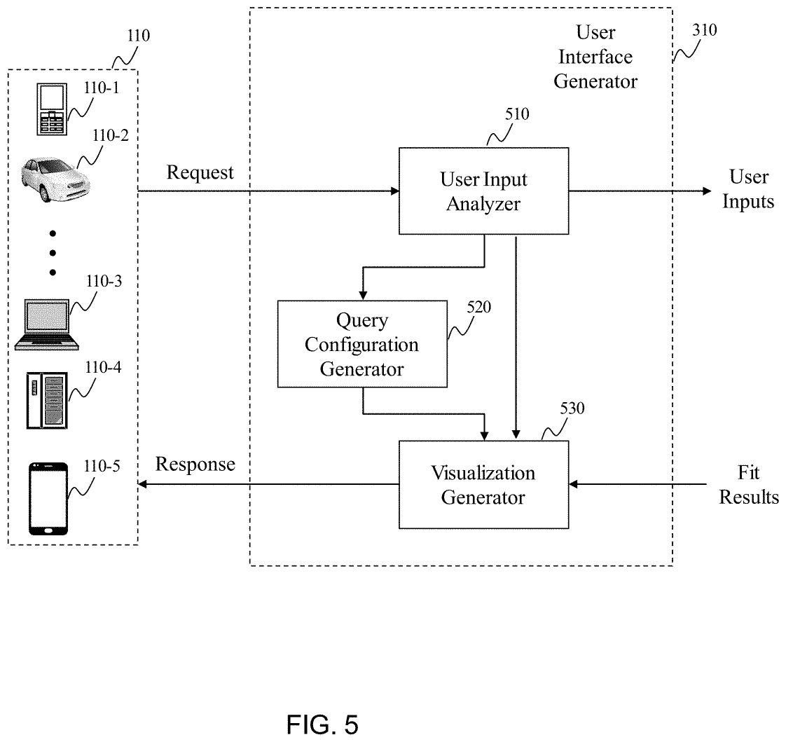

The user interface generator 310 in this example may generate a user interface, e.g. a graphic user interface (GUI), that receives user inputs related to fit prediction. Based on the user inputs, the user interface generator 310 may instruct the population engine 320 to run a simulation to generate simulated head data, instruct the fit engine 330 to determine a fit quality and nature for a wearable device design, and/or instruct the fit rule generator 340 to generate or update a fit rule or fit criteria for determining the fit quality and nature. Each of the components in the fit prediction system 140 may interact with any of the fit prediction related databases 150. The details of these interactions will be described later referring to FIGS. 5-12.

The real head database 150-1 stores real head data obtained either from the 3D scanner 130 or from a data purchase. Each real head data may include all data of a real person's head related to wearable device design. For example, the head data may include but not limited to: a width of the skull from ear to ear, pupillary distance, nose bridge width and shape, location of eye corners, height of cheeks, location of eyebrows, etc.

The simulated head database 150-2 stores simulated head data obtained from a simulation run on the population engine 320. The simulation may be performed based on part or whole of the real head data in the real head database 150-1. The simulated head data usually contains more head data than the real head data, e.g. by 100 times or 1000 times more. When the real head data provides a good representation of a target population, the simulated head data generated based on the real head data can also provide a good simulation of the target population.

Each of the real head database 150-1 and the simulated head database 150-2 is associated with the demographic database 150-3, which includes demographic information of persons whose head data are stored in the real head database 150-1 and/or the simulated head database 150-2. Demographic data may include, but not limited to, race, ethnicity, gender, and/or age of a person. Each of the real head database 150-1 and the simulated head database 150-2 is cross indexed with the demographic database 150-3. That is, a query of head data from the real head database 150-1 or 150-2 can also be used to retrieve a corresponding demographic data from the demographic database 150-3. Alternatively, a copy of the demographic information can be saved in the real head database 150-1 and/or the simulated head database 150-2 for easy data retrieval.

The wearable device database 150-4 stores wearable device data obtained from: e.g. a factory, a manufacturer, an inventory, an engineer design, a computer simulation, a proposal from a user, a market research, etc. The wearable device may include but not limited to, spectacles, eyeglasses, sunglasses, reader glasses, contact lenses, safety glasses, swimming goggles, virtual reality (VR) or augmented reality (AR) glasses, a helmet, a VR or AR helmet, smart glasses, or a combination thereto. For example, when the wearable device is eyeglasses, the wearable device data may include but not limited to: temple arm length, temple tip length, the angle formed by the temple arm and the temple tip, nose bridge width, lens width, lens height, pantoscopic tilt, retroscopic tilt, distance between lenses, effective lens diameter, face form angle/frame warp angle, presence/absence of nose pad, bridge type (such as Warby Parker's® standard bridge fit or low bridge fit), etc.

The fit rule database 150-5 stores fit rule data maintained by the fit rule generator 340. The fit rule generator 340 may generate and/or update rules and criteria for assessing a fit quality for a device design. For example, a fit rule may specify a temple arm length or a range of temple arm length that fits ear locations of a head data. A criterion may be used to calculate a fit probability or determine a misfit for a head data feature. For example, a criterion for fitting a head data with nose bridge width W is set to be W+/−1 mm. That is, a frame having a nose bridge width beyond the W+/−1 mm can be determined as a misfit for the head data, while a nose bridge width within the W+/−1 mm can be assigned a fit probability accordingly. A fit rule may specify pupil fit, such as a criterion for pupil fit can be P−2 mm to P+8 mm. One or more fit rules can be used to generate a desired head wearable device design outcome. For example, the one or more fit rules can be the overall width fit must be within a range and the pupillary distance fit must be within a range, which means that the head wearable device design must fit in the ear location and the pupil area to be a good fit. Some aspects of fit have one or more different fit tolerances because certain aspects of fit can be adjusted into place by an optician (such as the temple arms) while other aspects of fit cannot be adjusted by an optician (such as nose bridge of an acetate frame without adjustable nose pads). The size of the body part is also another reason why some aspects of fit have one or more different fit tolerances. For example, the +/−fit tolerance for overall head width is broader that it is for bridge width, and thus, +/−1 mm fit tolerance has a major impact for bridge width but has lesser impact for overall head width. Fit rules can be generated geometrically (as described above) and/or by experimentation. Generating one or more fit rules via experimentation requires, for example, obtaining the face dimensions of one or more subjects using a 3D scanner, and having the subjects try on ten or more designs of a head wearable device (such as eyeglasses) with different technical dimensions while one or more observers determine which designs of the head wearable device fit the subjects. One or more fit rules can be generated using the technical dimensions of the different head wearable device designs, the subjects' face dimensions, and the one or more observers' fit assessments.

Further, the fit probability distribution for one or more aspect of fit can be symmetrical or unsymmetrical around an “ideal size.” By way of example for unsymmetrical fit probability distribution, a misfit that is “too small” is likely to be rejected by a customer since the head wearable device design will not fit on customer's head. Meanwhile, a misfit that is “too big” may be acceptable to the customer. An example of this is shown in the above example fit rule for pupil fit (criterion for pupil fit can be P−2 mm to P+8 mm). Overall, the claimed invention helps identify a fit probability distribution, which then can be summarized in a +/−range. The claimed invention simplifies the fit probability distribution to be binary, assuming the fit probability is near 0 outside that range and high (e.g., somewhere between 0.5 and 1) inside that range.

In one embodiment, the 3D scanner 130 may be used to take accurate face measurements for creating the fit rules by the fit rule generator 340. The population engine 320 provides the population that will “try on” the frames. The fit engine 330 combines frame and population information, and then powers all of the user interfaces generated by the user interface generator 310. The user interfaces may be on various devices accessing and using the fit prediction system 140.

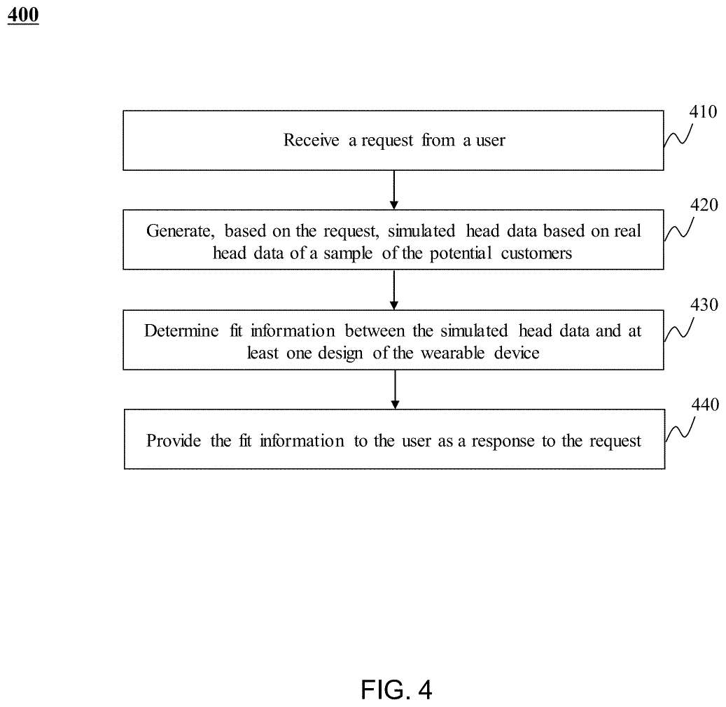

FIG. 4 is a flowchart of an exemplary process 400 performed by a fit prediction system, e.g. the fit prediction system 140 in FIG. 3, in accordance with some embodiments of the disclosure herein. At operation 410, a request is received from a user. At operation 420, simulated head data are generated based on real head data of a sample of subjects (including, but not limited to, potential and/or actual customers who have agreed to participate in the fit prediction system), according to the request. At operation 430, fit information is determined between the simulated head data and at least one design of the wearable device and/or the design of at least one wearable device. The fit information is provided at operation 440 to the user as a response to the request. The order of the operations shown in FIG. 4 may be changed according to different embodiments of the disclosure herein.

FIG. 5 illustrates an exemplary diagram of a user interface generator 310, e.g., the user interface generator 310 in FIG. 3, in accordance with some embodiments of the disclosure herein. The user interface generator 310 in this example includes a user input analyzer 510, a query configuration generator 520, and a visualization generator 530.

The user input analyzer 510 in this example may receive a request from a user, via a client device 110. The user may be an employee of a company owning or having an access to the fit prediction system 140. The request may be input by the user from a software or graphical user interface on the client device 110. The user interface may be generated by the user interface generator 310 and sent to the client device 110. Alternatively, the user interface may be generated by the client device 110 based on instructions created by the user interface generator 310.

The request may be to predict how arbitrary sets of eyeglass frames will fit arbitrary sets of people. For example, a user can use the user interface to count and describe faces that cannot find any good options in an assortment, to assess whether a new frame style would fit a specific face size, or to test out new sizing schemes (e.g., four different temple arm lengths) to see if they improve fit coverage in a given population.

The user input analyzer 510 may analyze the request to generate user input data. In one example, the user input data includes information about: the size and shape of one or more spectacles, which correspond to real or hypothetical designs; a population of one or more people, which the population engine 320 then generates. The user input analyzer 510 will send these user input data to the fit engine 330 to virtually “try on” every spectacle on every person in the specified population. The user input analyzer 510 may also send the user input data to the visualization generator 530 for generating response visualization.

The visualization generator 530 in this example may receive fit results generated by the fit engine 330 based on the user input data. The fit results can be aggregated, by the fit engine 330 or the visualization generator 530, in a way that is appropriate for the request. The visualization generator 530 may perform visualization to generate a visualized fit result based on the user input data and/or the fit results, and send the visualized fit result as a response of the request to the client device 110.

In one embodiment, after the user input analyzer 510 receives an initial request, the user input analyzer 510 forwards the request to the query configuration generator 520 to generate a query and a configuration. The query configuration generator 520 in this example can generate a query to ask the user to provide more information related to the request. For example, after a user requests a population to fit a certain frame design, the query configuration generator 520 can generate a query to ask the user to provide intended features or demographic information of the population. The query configuration generator 520 can generate different configurations of the demographic information, e.g., a bar that can be dragged from left to right to represent an age, different check boxes to represent a gender, etc. The query configuration generator 520 may send the generated queries and configurations to the visualization generator 530 for visualization. As such, the visualization generator 530 can generate visualized queries with configurations, and send them to the client device 110 as a response of the request.

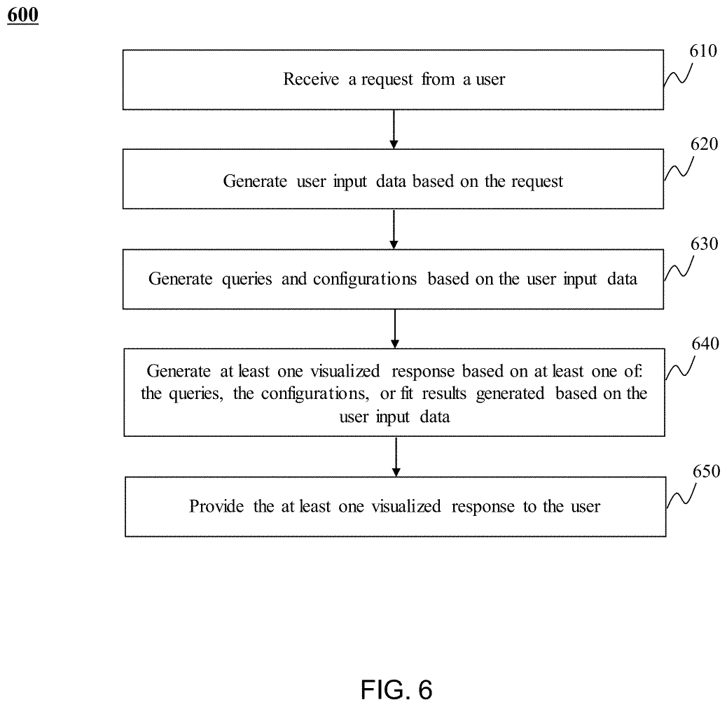

FIG. 6 is a flowchart of an exemplary process 600 performed by a user interface generator, e.g., the user interface generator 310 in FIG. 3 and FIG. 5, in accordance with some embodiments of the disclosure herein. At operation 610, a request is received from a user. At operation 620, user input data are generated based on the request. Optionally at operation 630, queries and configurations are generated based on the user input data. At operation 640, at least one visualized response is generated based on at least one of: the queries, the configurations, or fit results generated based on the user input data. At operation 650, the at least one visualized response is provided to the user. The order of the operations shown in FIG. 6 may be changed according to different embodiments of the disclosure herein.

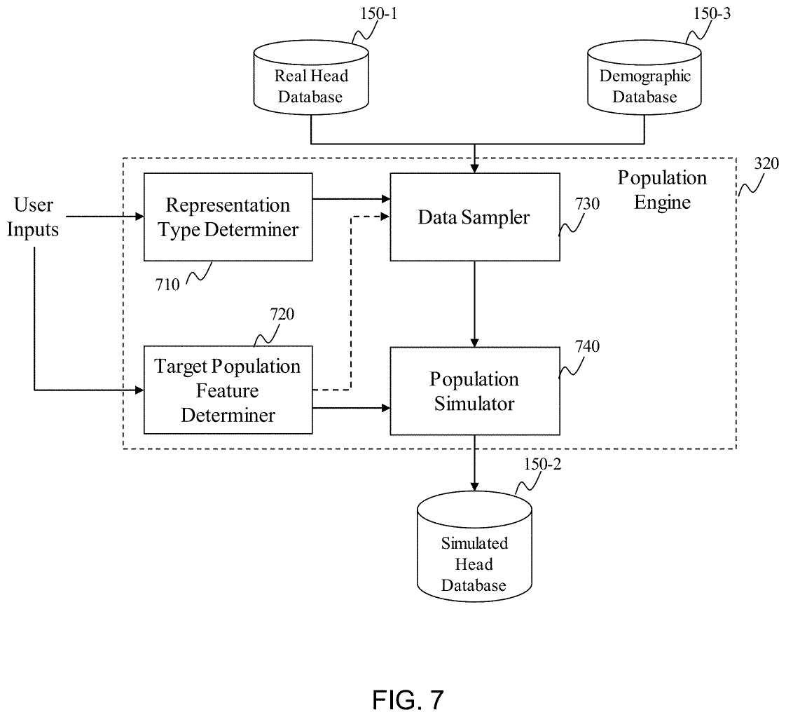

FIG. 7 illustrates an exemplary diagram of a population engine 320, e.g., the population engine 320 in FIG. 3, in accordance with some embodiments of the disclosure herein. The population engine 320 in this example includes a representation type determiner 710, a target population feature determiner 720, a data sampler 730, and a population simulator 740. According to various embodiments, the population engine 320 uses a data set of thousands of face scans of subjects and demographic data about the subjects to run a simulation, and returns a simulated population representative of actual populations in the world. These simulated faces may be fed into the fit engine 330 to “try on” the spectacles.

The representation type determiner 710 in this example may receive user input data from the user interface generator 310. Based on the user input data, the representation type determiner 710 can determine a representation type for sampling the real head or face data for simulation. The data in the real head database 150-1 may include facial scans, while the data in the demographic database 150-3 may include demographic information (e.g., race/ethnicity, binary gender, and age) associated with the facial data in the real head database 150-1. A data sample used for simulation may include e.g., about 2,500 participants with balanced gender representation as well as representation across several different ethnic groups. Whether the data sample can represent across different demographic groups depend on the user input data, because the user may want more data simulated for a gender or an age group when running the simulation. As such, the representation may be equal representation or bias representation towards a specified demographic group. The representation type determiner 710 can send the generated representation type to the data sampler 730 for generating the data sample.

The data sampler 730 in this example may receive the representation type and the user input data from the representation type determiner 710, and generate a data sample from the real head database 150-1 and the associated 150-2, based on the representation type and the user input data. This is a sample of real head data with associated demographic information determined based on the representation type. The data sampler 730 can send the data sample to the population simulator 740 for performing the simulation.

The distributions of certain measurements can vary between demographic groups (such as, but not limited to, age, gender, race and/or ethnicity, medical condition, and injury). Such differences, however, large or small, can be seen in the mean and variance of measurements. By way of example, the differences in averages between sexes are fairly large for many face measurements (especially, overall head width and pupillary distance). Such measurements include, but not limited to, head width, nose bridge width (such as, but not limited to, the width of the nose at the point where the head wearable device sits on or above the nose), pupillary distance, nasal width (horizontal measurement that captures the maximum soft-tissue width of the nose at the level of the alae—measuring the distance between the right and left alares), subnasal width (horizontal measurement of the nasal floor, at the interface between the nose and upper lip—measuring the distance between the right and left subalares), nasal protrusion (projective measurement of the nose spanning the subnasal surface, from the nasal floor to the nasal tip—measuring the distance between pronasale and subnasale); nasal ala length right/left (projective measurement of the nose spanning the subnasal surface, from the nasal floor to the nasal tip—measuring between pronasale and right/left alar curvature point, respectively), nasal height (measurement between nasion to subnasale), nasal bridge length (measurement between nasion to pronasale), nasofrontal angle, intercanthal width (measurement between right and left endocanthions), outercanthal width (measurement between right and left exocanthions) and cheek position relative to nose bridge). Also, differences in nose shape (e.g., nose bridge shape; nasal shape, head shape; cheek position relative to nose bridge) can vary between demographic groups, and heavily informs potential geometric shape and/or size of the frame.

It is important to be thoughtful about resampling the population by demographic information when designing head wearable devices. For instance, the data sampler 730 can resample the scan data, weighted by demographic information, to produce a simulation of what a realistic sample of 80,000 Americans would look like. A user can also generate a sample that has equal representation across all of the demographic subgroups, such that the user could take a closer look at the options available to each subgroup in the assortment. This could also be applied to create any arbitrary population, such as a population in a country, city, or a neighborhood. Based on the resampling, the user could also create populations that may have specific fit needs, such as an older population who wear progressive lenses. Such resampling heavily informs the assorting process and picking colors, design details, style names, etc. of potential head wearable device de signs.

The population simulator 740 in this example may receive the data sample from the data sampler 730, and generate head data of a simulated population based on the data sample. For example, the simulation may utilize data interpolation to generate simulated head data of an age group between two age groups with real head data and otherwise same demographic information. The population simulator 740 can store the simulated head data into the simulated head database 150-2. In one embodiment, the population simulator 740 sends the simulated head data to the fit engine 330 directly for fit assessment.

The target population feature determiner 720 in this example may receive user input data from the user interface generator 310, and determine a target population feature. For example, the target population feature determiner 720 may determine that the user is interested in creating measurement-based subsets, such as “the widest 10% head of men.” For this population feature, the data sampler 730 could make a broader sample as described above. Then after the population simulator 740 performs the simulation, the population simulator 740 filters based on the population feature to retain only the simulated people who are male and whose head width is in the top 10% for all men. This filter could be applied to arbitrary features, like high cheeks, low eyebrows, etc. This is useful for investigating how to best fit each particular population. For example, maybe the wider heads also need wider nose bridges or longer temple arms. If so, the simulated data may reflect a number of people that are affected and by how much. In one embodiment, the target population feature determiner 720 may send the population feature to the data sampler 730, such that the data sampler 730 may generate a data sample with the population feature, e.g., low eyebrows, only.

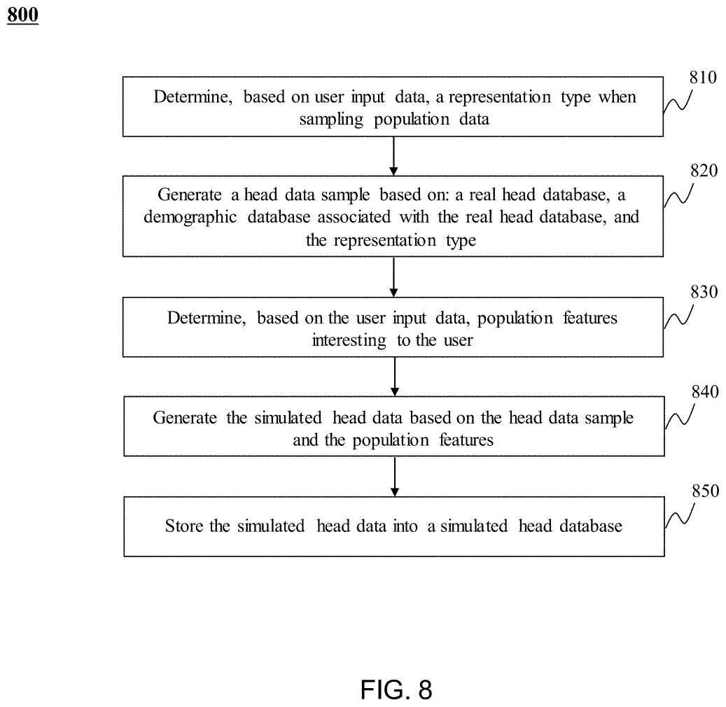

FIG. 8 is a flowchart of an exemplary process performed by a population engine, e.g., the population engine 320 in FIG. 3 and FIG. 7, in accordance with some embodiments of the disclosure herein. At operation 810, a representation type is determined based on user input data for sampling population data. At operation 820, a head data sample is generated based on: a real head database, a demographic database associated with the real head database, and the representation type. At operation 830, population features interesting to the user are generated based on the user input data. The simulated head data are generated at operation 840 based on the head data sample and the population features. At operation 850, the simulated head data are stored into a simulated head database. The order of the operations shown in FIG. 8 may be changed according to different embodiments of the disclosure herein.

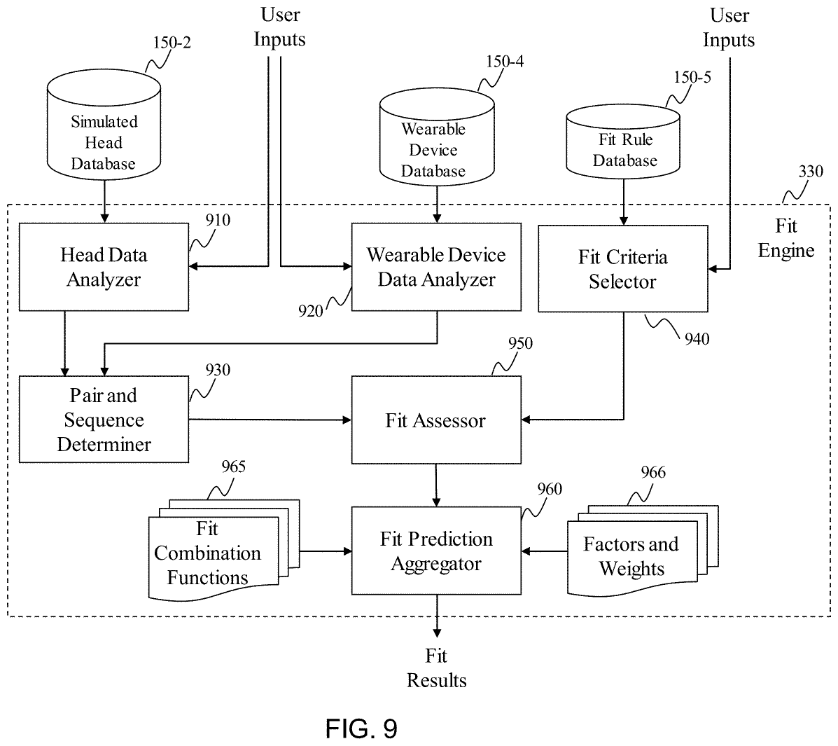

FIG. 9 illustrates an exemplary diagram of a fit engine 330, e.g., the fit engine 330 in FIG. 3, in accordance with some embodiments of the disclosure herein. The fit engine 330 in this example includes a head data analyzer 910, a wearable device data analyzer 920, a pair and sequence determiner 930, a fit criteria selector 940, a fit assessor 950, and a fit prediction aggregator 960. The fit engine 330 can analyze the three dimensional face data and three dimensional frame data, and outputs a probability that they will fit based on rules collected and stored.

The head data analyzer 910 in this example may retrieve and analyze head data from the simulated head database 150-2 based on user input data from the user interface generator 310. Here it is assumed that the head data retrieved from the simulated head database 150-2 already includes associated demographic data. If not, the head data analyzer 910 can also retrieve the associated demographic data from the demographic database 150-3. In one embodiment, the head data analyzer 910 can also retrieve and analyze head data from the real head database 150-1 and the simulated head database 150-2 based on user input data. The head data analyzer 910 can send the retrieved and analyzed head data to the pair and sequence determiner 930 for pairing. In one embodiment, each head data may be assigned a weight by the head data analyzer 910 and sent to the pair and sequence determiner 930 with the weight. The weight may be determined based on the user input data that reflect the user's preference.

The wearable device data analyzer 920 in this example may retrieve and analyze design data of a wearable device, e.g., a pair of eyeglasses or VR goggle, from the wearable device database 150-4 based on user input data. The wearable device data analyzer 920 can send the retrieved and analyzed design data to the pair and sequence determiner 930 for pairing.

The pair and sequence determiner 930 in this example may pair the retrieved head data and the retrieved device design data to generate a sequence of data pairs. Each data pair comprises a head data and a corresponding device design data. Each of the retrieved head data may be paired with each of the retrieved device design data, to form different head-design data pairs. The pair and sequence determiner 930 may determine a sequence for the different head-design data pairs for fit assessment, e.g., based on weights of the head data determined by the head data analyzer 910. The pair and sequence determiner 930 can send the sequence of head-design data pairs to the fit assessor 950 for fit assessment.

The fit criteria selector 940 in this example may select rules and criteria from the fit rule database 150-5 based on the user input data. Each rule in the fit rule database 150-5 specifies how to determine a fit probability of a device design regarding a head data, in terms of a head feature and/or a device parameter. Based on the user input data, the fit criteria selector 940 can select different rules associated with different criteria for assessing a fit quality and nature between the retrieved head data from the head data analyzer 910 and the retrieved device design data from the wearable device data analyzer 920. For example, for each frame, the fit criteria selector 940 can select five fit criteria that were determined to be most critical to fit overall by specially trained experts. The rules may also be generated based on big data analysis, e.g., by trying on a variety of spectacles on a wide variety of faces, making sure to include people from a wide variety of sizes and demographic groups.

The fit assessor 950 in this example may receive the sequence of head-design data pairs from the pair and sequence determiner 930 and the selected rules and criteria from the fit criteria selector 940. The fit assessor 950 can then assess the sequence of data pairs, based on each of the selected rules and criteria, to generate a fit prediction for each data pair. The fit assessment may repeat across all of the data pairs. Each fit prediction here may refer to a rule associated with a head or design feature. For example, a fit prediction here may include: an overall width fit that has 75% chance for the frame to be too wide, a pupil fit that has a 66% chance of a good fit, an 80% chance that nose bridge is too narrow, etc. In one embodiment, the fit assessor 950 can assess a likelihood of a good fit and/or the reason for a misfit, if any. In one embodiment, the fit predictions may be issued as a set of three probabilities for each fit aspect (e.g., pupil fit): the probability of the fit aspect being too narrow, just right, or too wide. Parameters of good v. bad fit are adjustable and can depend on the customer's or demographic group's preferences. For example, a good pupil fit can mean the pupils should be centered in the lens or near the center of the lens. The term “near the center of the lens,” as used in this application, is defined as the pupil falls less than or equal to 4 mm to 6 mm; 4 mm to 10 mm; 4 mm to 8 mm; 5 mm to 7 mm; 6 mm to 8 mm; 6 mm to 10 mm; 7 mm to 9 mm; 8 mm to 10 mm; 4 mm; 5 mm; 6 mm; 7 mm; 8 mm; 9 mm; or 10 mm horizontally from the vertical axis of the geometric center of the lens. Another example, a good overall head width can mean the frame of a head wearable device should not pinch the temples or the customer should be able to fit two fingers between the heads temples and the frame's temple arms. A good fit can also include having the face cheeks not touch the frame when the customer's smiles and/or the eyebrows are above the frame. For an example good bridge fit, the frame's bridge should not be wide enough so that the frame will sit too low on the nose and/or the frame's bridge should not be narrow enough so that the frame will sit too high on the nose.

In one embodiment, the fit engine 330 may output the fit prediction for a single aspect of fit from the fit assessor 950 as a fit result. In another embodiment, the fit engine 330 may use an ensemble model containing several sub-models each evaluating a different aspect of fit, to combine the predictions into a single prediction output. In that case, the fit assessor 950 may send the generated fit predictions to the fit prediction aggregator 960 for aggregation.

The fit prediction aggregator 960 in this example may receive the fit predictions from the fit assessor 950, and generate an aggregated fit prediction across all fit aspects. For example, the aggregated fit prediction may indicate a 90% overall fit probability for a head-design data pair. In one example, when the aggregated fit prediction indicates an overall fit probability lower than a threshold, e.g., 60%, the fit prediction aggregator 960 may generate a reason for the misfit associated with the low fit probability, to indicate one or more critical fit aspects that make the overall fit score lower. The fit prediction aggregator 960 may output the aggregated fit prediction and/or the misfit reason, as a fit result for each data pair.

In one embodiment, the fit prediction aggregator 960 may utilize one of the fit combination functions 965 stored in the fit engine 330 to combine the fit predictions from the fit assessor 950. One example of the fit combination function 965 is a geometric mean, although a more complex and flexible combination function may also be used. Since an eyewear device may fit perfectly in one area of the face and be a bad fit in other areas, a bad fit in just a single aspect could result in an overall declaration of “misfit,” even if the other aspects are likely to fit well. For instance, some people have eyes that are narrower than average, relative to their head width. It is common for those people to find frames that are a good width for their head and nose bridge, but are much too wide in the pupil.

In one embodiment, the fit prediction aggregator 960 may incorporate one or more factors weighted on the combination of the fit predictions from the fit assessor 950. The fit prediction aggregator 960 may retrieve one of the factors 966 with an associated weight stored in the fit engine 330. For example, a prescription strength may be incorporated into the weighting of the factors for prediction combination. For instance, frames that are too wide in the pupil cause unacceptable problems for strong prescriptions, but not for weak prescriptions. The specific customer prescription (or the distribution of prescription strengths in the population) could be factored into the way that different aspects of fit are combined.

To issue predictions across an assortment of frames and/or a group of multiple people, the fit engine 330 essentially create a list of all the different face-frame pairs and assess their fit quality and nature one by one. The results can then be aggregated in whatever way that is most applicable to the investigation. As discussed above, the aggregation may be performed in the fit prediction aggregator 960 or in the user interface generator 310.

In one embodiment, technology like deep learning may be used to provide more complex fit assessments by the fit assessor 950 or the entire 330. Deep learning can be used to assess the whole frame and face data at once. This would also make it easier to use more complex measurements, like a curve rather than a point-to-point distance, and to do e.g., physical modeling of frame fit to see where the specific spectacles meet this specific nose, rather than simply comparing measurements. Deep learning would need a much larger training set, but could update the fit models of the fit engine 330 as people use them. The fit engine 330 may learn from customer selections for home try-on, their purchases, and returns to refine the fit predictions of whether it fits in the real world.

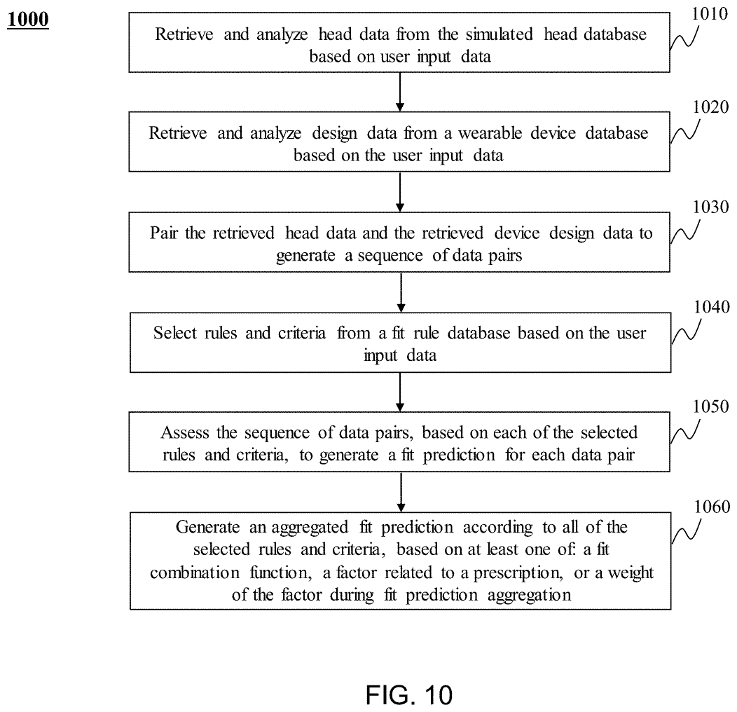

FIG. 10 is a flowchart of an exemplary process performed by a fit engine, e.g., the fit engine 330 in FIG. 3 and FIG. 9, in accordance with some embodiments of the disclosure herein. At operation 1010, head data are retrieved and analyzed from the simulated head database based on user input data. At operation 1020, design data are retrieved and analyzed from the wearable device database based on the user input data. At operation 1030, the retrieved head data and the retrieved device design data are paired to generate a sequence of data pairs. Rules and criteria are selected at operation 1040 from a fit rule database based on the user input data. At operation 1050, the sequence of data pairs are assessed, based on each of the selected rules and criteria, to generate a fit prediction for each data pair. At operation 1060, an aggregated fit prediction is generated according to all of the selected rules and criteria, based on at least one of: a fit combination function, a factor related to a prescription, or a weight of the factor during fit prediction aggregation. The order of the operations shown in FIG. 10 may be changed according to different embodiments of the disclosure herein.

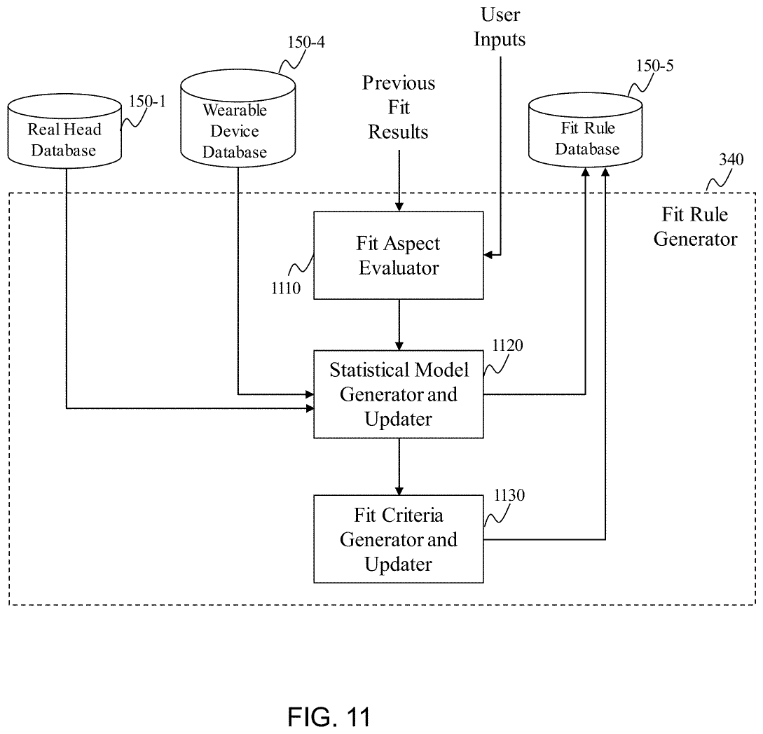

FIG. 11 illustrates an exemplary diagram of a fit rule generator 340, e.g., the fit rule generator 340 in FIG. 3, in accordance with some embodiments of the disclosure herein. The fit rule generator 340 in this example includes a fit aspect evaluator 1110, a statistical model generator and updater 1120, and a fit criteria generator and updater 1130. The fit rule generator 340 uses the data collected to guide the fit rules. The fit rule generator 340 may select particular fit criteria that matter most to an overall fit success.

The fit aspect evaluator 1110 in this example may receive a previous fit result based on the user input data. When the user wants to generate or update the fit rule database 150-5, the user input data may instruct the fit engine 330 to send the fit results previously generated by the fit engine 330 to the fit rule generator 340 as a feedback. The fit aspect evaluator 1110 may evaluate the fit prediction feedback to identify one or more rules to be generated or updated. Some measurements are frequently used to fit an eyewear device, such as pupillary distance. For instance, the fit aspect evaluator 1110 could analyze the previous fit results to determine that there is a large group of people who cannot find a good fit because of a combination of high and narrow nose bridge and very low eyebrows. This enables new kinds of eyewear size categories, like adding a dimension to the sizing system based on the temple arm length. Just like men's pants have a waist measurement and a length measurement, spectacles could have independent width and temple sizes. These sizes (e.g., narrow, small, long, wide, low, high, etc.) are different from the industry-standard eyewear measurements (in millimeters) that are generally printed on every pair of spectacles. The three numerical industry-standard measurements are difficult to understand and apply. The rules and criteria in the fit rule database 150-5 enables a more human-centered sizing system that is simple enough to understand yet detailed enough to allow people to find a good fit. The fit aspect evaluator 1110 may send the evaluation result to the statistical model generator and updater 1120.

The statistical model generator and updater 1120 in this example may receive: real head data (e.g., generated by a 3D scanner), design data of a wearable device, and the evaluation result from the fit aspect evaluator 1110. The evaluation result may indicate different aspects of fit, e.g., too wide at the pupil, too narrow at the temple, for each data pair. The statistical model generator and updater 1120 may utilize the statistics in the evaluation result to generate or update at least one fit rule based on at least one of: the evaluation of fit predictions, the real head data, or the design data of the wearable device. The statistical model generator and updater 1120 may store the generated or updated at least one fit rule in the fit rule database 150-5. The statistical model generator and updater 1120 may forward the generated or updated at least one fit rule, as well as other data to the fit criteria generator and updater 1130.

The fit criteria generator and updater 1130 in this example may receive: the real head data (e.g., generated by a 3D scanner), the design data of the wearable device, the evaluation result, and the generated or updated at least one fit rule from the statistical model generator and updater 1120. The fit criteria generator and updater 1130 may utilize the statistics in the evaluation result to generate or update at least one fit criterion based on at least one of: the at least one fit rule, the evaluation of fit predictions, the real head data, or the design data of the wearable device. The fit criteria generator and updater 1130 may store the generated or updated at least one criterion in the fit rule database 150-5. This may be an iterative process, where the updated rule and/or criterion will be used by the fit engine 330 to generate new fit results in next iteration, such that the new fit results will be used by the fit rule generator 340 to generate or update rule and/or criterion again in next iteration. Different statistical models may be used to describe a fit rule. An aggregated model may also be used to describe fit rule in one embodiment.

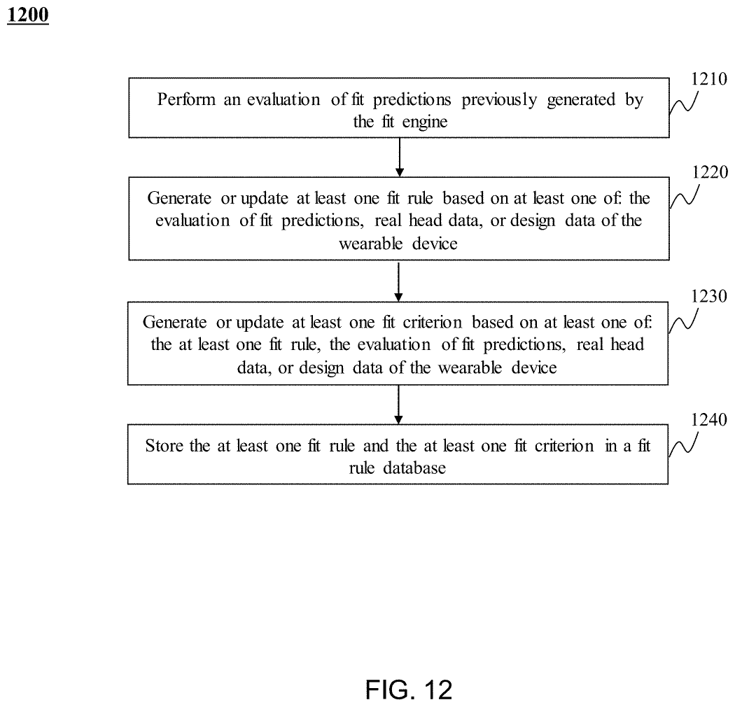

FIG. 12 is a flowchart of an exemplary process performed by a fit rule generator, e.g., the fit rule generator 340 in FIG. 3 and FIG. 11, in accordance with some embodiments of the disclosure herein. At operation 1210, an evaluation of fit predictions previously generated is performed by the fit engine. At operation 1220, at least one fit rule is generated or updated based on at least one of: the evaluation of fit predictions, real head data, or design data of the wearable device. At operation 1230, at least one fit criterion is generated or updated based on at least one of: the at least one fit rule, the evaluation of fit predictions, real head data, or design data of the wearable device. The at least one fit rule and the at least one fit criterion are stored at operation 1240 in a fit rule database. The order of the operations shown in FIG. 12 may be changed according to different embodiments of the disclosure herein.

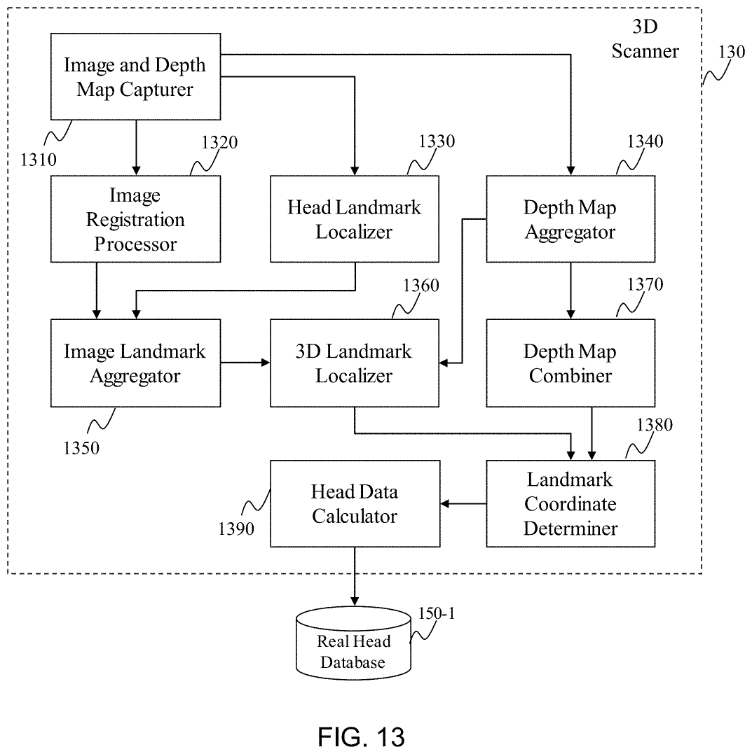

FIG. 13 illustrates an exemplary diagram of a three-dimensional (3D) scanner 130, e.g., the 3D scanner 130 in FIGS. 1-3, in accordance with some embodiments of the disclosure herein. The 3D scanner 130 in this example includes an image and depth map capturer 1310, an image registration processor 1320, a head landmark localizer 1330, a depth map aggregator 1340, an image landmark aggregator 1350, a 3D landmark localizer 1360, a depth map combiner 1370, a landmark coordinate determiner 1380, and a head data calculator 1390. In one embodiment, the 3D scanner 130 is a custom measurement device with protocol to obtain a full-face scan for accurate measurements of facial features that are critical to fitting spectacles.

The image and depth map capturer 1310 in this example may obtain, from each of three different views, a plurality of captures each including a 2D image and a corresponding 3D depth map of a head of a subject. For example, the image and depth map capturer 1310 may be implemented as a camera to obtain 15 captures of the head in quick succession, each including a 2D image and a depth map from three different views: a head-on view and two three-quarters views on each side of the head. The image and depth map capturer 1310 may send the 2D images to the image registration processor 1320 and the head landmark localizer 1330, and send the 3D depth maps to the depth map aggregator 1340.

In one embodiment, for each view, the depth map aggregator 1340 may average the 15 depth maps to create a single high-quality depth map for that view. For the 2D images, the image registration processor 1320 may perform a registration process in which small displacements due to camera motion are measured. In each 2D image, the head landmark localizer 1330 may localize key facial landmarks to determine 2D landmark locations. The image landmark aggregator 1350 may average together the 2D landmark locations determined by the head landmark localizer 1330, taking into account the small displacements estimated during the registration process by the image registration processor 1320.

The 3D landmark localizer 1360 may localize the facial landmarks in 3D space with the aid of the averaged depth maps from the depth map aggregator 1340, to obtain an average depth map and a set of 3D landmark locations for each view. The depth map combiner 1370 may use an iterative closest point algorithm to join together the depth maps from the three views into a single depth map.

Following the joining of the depth maps, the landmark coordinate determiner 1380 can determine landmark coordinates based on the single depth map, e.g., the landmark coordinates from the left side of the face are drawn from the left depth map, the landmark coordinates from the center of the face are drawn from the head-on depth map, and the landmark coordinates from the right side of the face are drawn from the right depth map. Finally, the head data calculator 1390 may calculate head data based on the landmark coordinates, including e.g., distances between the various landmarks. The head data calculator 1390 can store the head data into the real head database 150-1.

In one embodiment, the 3D scanner 130 provides accurate readings of the head (including the front, sides, and, optionally, top and/or back of the head). In addition to the determining location of facial landmarks, the 3D scanner also determines locations of the ears on the head, as well as the overall width of the skull, which are crucial measurements for fitting head wearable devices. As a result, the 3D scanner 130 scans at least the front and sides of the head and optionally, the top and/or back of the head.

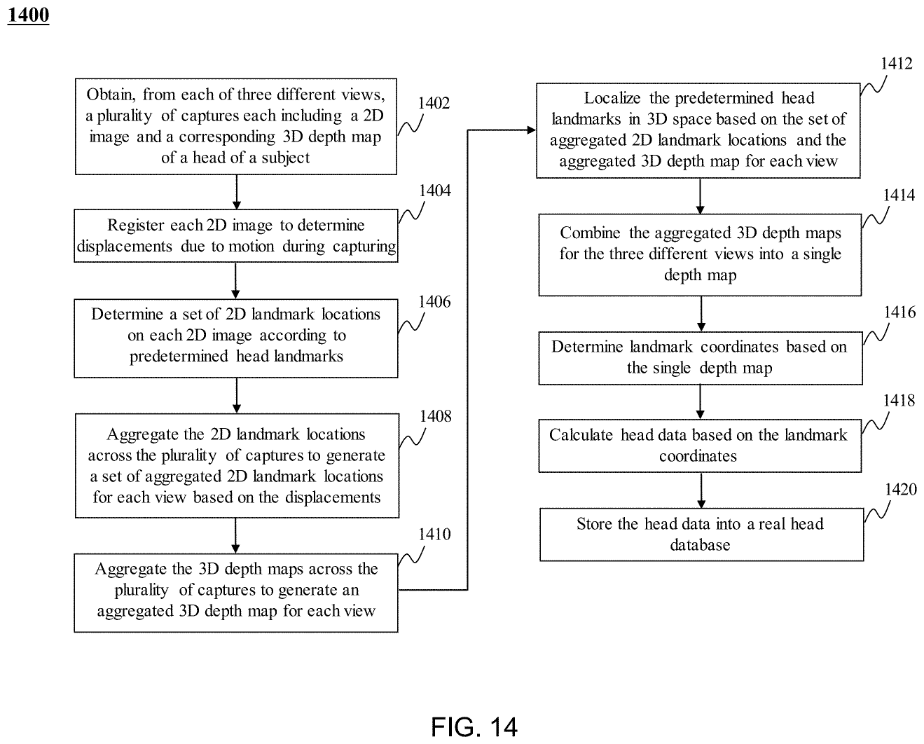

FIG. 14 is a flowchart of an exemplary process performed by a 3D scanner, e.g., the 3D scanner 130 in FIGS. 1-3 and 13, in accordance with some embodiments of the disclosure herein. At operation 1402, a plurality of captures each including a 2D image and a corresponding 3D depth map of a head of a subject, are obtained from each of three different views. At operation 1404, each 2D image is registered to determine displacements due to motion during capturing. At operation 1406, a set of 2D landmark locations are detected or determined on each 2D image according to, for example, predetermined head landmarks. At operation 1408, the 2D landmark locations are aggregated across the plurality of captures to generate a set of aggregated 2D landmark locations for each view based on the displacements. At operation 1410, the 3D depth maps are aggregated across the plurality of captures to generate an aggregated 3D depth map for each view. At operation 1412, the predetermined head landmarks are localized in 3D space based on the set of aggregated 2D landmark locations and the aggregated 3D depth map for each view. At operation 1414, the aggregated 3D depth maps are combined for the three different views into a single depth map. At operation 1416, landmark coordinates are determined based on the single depth map. At operation 1418, head data are determined based on the landmark coordinates. At operation 1420, the head data are stored into a real head database. The order of the operations shown in FIG. 14 may be changed according to different embodiments of the disclosure herein.

In various embodiments of the disclosure herein, more nuanced statistical models that incorporate more detailed measurements (such as 6 measurements of the nose bridge instead of 2, or a curve rather than a single distance) can implemented. In various embodiments, methods are used for: predicting whether faces will fit low bridge fit frames; examining nose bridge fit in detail, which is a combination of two very complex topologies; examining common fit problems in more detail, such as low eyebrows, high cheeks, narrow pupillary distance, broken noses, asymmetries, etc.; visualizing the spectacles on the face scan, to see how new designs would look on many different faces; creating a set of sample faces to capture each of the various face “types,” to use as design models (e.g., one narrow face with a high bridge, one narrow face with narrow-set eyes, etc.); creating a target metric to allow every person have N frames in the assortment that are likely to fit them; using a physical model to have the spectacles and face “collide” to better examine how they sit on the face; higher fidelity scanning; using deep learning to generate an image of eyeglasses worn by a simulated model who properly fits the spectacles for ad campaigns, so that customers are not confused about how fit works by having human models wearing frames that do not fit properly; after scanning a customer's face, narrowing the frame list down to just frames that will fit them (see., e.g., PCT International Application Publication No. WO 2020/142295, which is incorporated by reference herein in its entirety); generating marketing emails targeted to highlight frames in the collection that are likely to fit the individual recipient; adjusting frames in the lab before shipping them to the customer based on their scan measurements, saving them a trip to the store for an adjustment.

The disclosure herein can be embodied in the form of methods and apparatus for practicing those methods. The disclosure herein can also be embodied in the form of program code embodied in tangible media, such as secure digital (“SD”) cards, USB flash drives, diskettes, CD-ROMs, DVD-ROMs, Blu-ray disks, hard drives, or any other non-transitory machine-readable storage medium, wherein, when the program code is loaded into and executed by a machine, such as a computer, the machine becomes an apparatus for practicing the disclosure. The disclosure herein can also be embodied in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the disclosure. When implemented on a general-purpose processor, the program code segments combine with the processor to provide a unique device that operates analogously to specific logic circuits.

It may be emphasized that the above-described embodiments are merely possible example s of implementations, and merely set forth a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the disclosure herein and protected by the following claims.

While this specification contains many specifics, these should not be construed as limitations on the scope of any disclosure or of what may be claimed, but rather as descriptions of features that may be specific to particular embodiments of particular disclosures. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

While various embodiments have been described, it is to be understood that the embodiments described are illustrative only and that the scope of the subject matter is to be accorded a full range of equivalents, many variations and modifications naturally occurring to those of skill in the art from a perusal hereof

What is claimed is:

1. A system having at least one processor and at least one memory for predicting a fit quality between a wearable device and one or more customers, comprising:
a user interface generator configured for receiving a request from a user;
a population engine configured for generating, based on the request, simulated head data based on real head data of a sample of subjects; and
a fit engine configured for determining fit information between the simulated head data and at least one design of the wearable device, wherein the fit information is displayed to the user as a response to the request.

2. The system of claim 1, wherein the request includes information related to at least one of:
a target customer population with predetermined demographic data; or
a proposed set of wearable device designs each of which includes respective size and shape data of the wearable device.

3. The system of claim 2, wherein the request is related to at least one of:
seeking, among the target customer population, a subset of population having a fit probability larger or smaller than a predetermined threshold based on the proposed set of wearable device designs;
seeking, among the proposed set of wearable device designs, a subset of designs having a fit probability larger or smaller than a predetermined threshold based on the target customer population; or
determining fit information between the proposed set of wearable device designs and the target customer population.

4. The system of claim 1, wherein the user interface generator comprises:
a user input analyzer configured for receiving the request from the user and generating user input data based on the request;
a query configuration generator configured for generating queries and configurations based on the user input data; and
a visualization generator configured for:
generating at least one visualized response based on at least one of: the queries, the configurations, or fit results generated based on the user input data, and
providing the at least one visualized response to the user.

5. The system of claim 4, wherein the population engine comprises:
a representation type determiner configured for determining, based on the user input data, a representation type when sampling population data;
a data sampler configured for generating a head data sample based on: a real head database, a demographic database associated with the real head database, and the representation type;
a target population feature determiner configured for determining, based on the user input data, population features interesting to the user; and
a population simulator configured for generating simulated head data based on: the head data sample and the population features, and storing the simulated head data into a simulated head database.

6. The system of claim 5, wherein the fit engine comprises:
a head data analyzer configured for retrieving and analyzing head data from the simulated head database based on the user input data;
a wearable device data analyzer configured for retrieving and analyzing device design data from a wearable device database based on the user input data;
a pair and sequence determiner configured for pairing the retrieved head data and the retrieved device design data to generate a sequence of data pairs;
a fit criteria selector configured for selecting rules and criteria from a fit rule database based on the user input data; and
a fit assessor configured for assessing the sequence of data pairs, based on each of the selected rules and criteria, to generate a fit prediction for each data pair, wherein the fit prediction includes information related to at least one of: an indication of a fit based on a predetermined threshold, a fit probability of a fit, or a reason of a misfit.

7. The system of claim 6, wherein the fit engine further comprises:
a fit prediction aggregator configured for generating an aggregated fit prediction according to all of the selected rules and criteria, wherein the aggregated fit prediction is generated based on at least one of: a fit combination function, a factor related to a prescription, or a weight of the factor during fit prediction aggregation.

8. The system of claim 1, further comprising a fit rule generator configured for generating or updating fit rules and criteria for assessing a fit quality of a head device data pair, wherein the fit rule generator comprises:
a fit aspect evaluator configured for performing an evaluation of fit predictions previously generated by the fit engine;
a statistical model generator and updater configured for generating or updating at least one fit rule based on at least one of: the evaluation of fit predictions, real head data, or design data of the wearable device; and
a fit criteria generator and updater configured for generating or updating at least one fit criterion based on at least one of: the at least one fit rule, the evaluation of fit predictions, real head data, or design data of the wearable device, wherein the at least one fit rule and the at least one fit criterion are stored in a fit rule database.

9. The system of claim 1, further comprising a three-dimensional (3D) scanner configured for scanning heads to generate real head data, wherein the 3D scanner comprises:
an image and depth map capturer configured for obtaining a plurality of captures from each of three different views, wherein each of the plurality of captures includes a two-dimensional (2D) image and a corresponding 3D depth map of a head of a subject;
an image registration processor configured for registering each 2D image to determine displacements due to motion during capturing;
a head landmark localizer configured for detecting a set of 2D landmark locations on each 2D image;
an image landmark aggregator configured for aggregating the 2D landmark locations across the plurality of captures to generate a set of aggregated 2D landmark locations for each view based on the displacements;
a depth map aggregator configured for aggregating the 3D depth maps across the plurality of captures to generate an aggregated 3D depth map for each view;
a 3D landmark localizer configured for localizing the predetermined head landmarks in 3D space based on the set of aggregated 2D landmark locations and the aggregated 3D depth map for each view;
a depth map combiner configured for combining the aggregated 3D depth maps for the three different views into a single depth map;
a landmark coordinate determiner configured for determining landmark coordinates based on the single depth map; and
a head data calculator configured for calculating head data based on the landmark coordinates and storing the head data into a real head database.

10. The system of claim 1, wherein the wearable device is spectacles, eyeglasses, sunglasses, contact lenses, smart glasses, safety glasses, swimming goggles, virtual reality (VR) glasses, augmented reality (AR) glasses, a helmet, a VR helmet, AR glasses, or a combination thereof.

11. The system of claim 1, wherein the one or more customers are potential customers, actual customers, or a combination thereof.

12. A method implemented on a computing device having at least one processor and at least one memory for predicting a fit quality between a wearable device and one or more customers, comprising:
receiving a request from a user;
generating, based on the request, simulated head data based on real head data of a sample of the customers;
determining fit information between the simulated head data and at least one design of the wearable device; and
providing the fit information to the user as a response to the request.

13. The method of claim 12, wherein the request includes information related to at least one of:
a target customer population with predetermined demographic data; or
a proposed set of wearable device designs each of which includes respective size and shape data of the wearable device.

14. The method of claim 13, wherein the request is related to at least one of:
seeking, among the target customer population, a subset of population having a fit probability larger or smaller than a predetermined threshold based on the proposed set of wearable device designs;
seeking, among the proposed set of wearable device designs, a subset of designs having a fit probability larger or smaller than a predetermined threshold based on the target customer population; or
determining fit information between the proposed set of wearable device designs and the target customer population.

15. The method of claim 12, further comprising:
generating user input data based on the request;
generating queries and configurations based on the user input data;
generating at least one visualized response based on at least one of: the queries, the configurations, or fit results generated based on the user input data; and
providing the at least one visualized response to the user.

16. The method of claim 15, wherein generating the simulated head data comprises:
determining, based on the user input data, a representation type when sampling population data;
generating a head data sample based on: a real head database, a demographic database associated with the real head database, and the representation type;
determining, based on the user input data, population features interesting to the user; and
generating the simulated head data based on the head data sample and the population features, wherein the simulated head data are stored into a simulated head database.

17. The method of claim 16, wherein determining the fit information comprises:
retrieving and analyzing head data from the simulated head database based on the user input data;
retrieving and analyzing device design data from a wearable device database based on the user input data;
pairing the retrieved head data and the retrieved device design data to generate a sequence of data pairs;
selecting rules and criteria from a fit rule database based on the user input data; and
assessing the sequence of data pairs, based on each of the selected rules and criteria, to generate a fit prediction for each data pair, wherein the fit prediction includes information related to at least one of: an indication of a good fit or bad fit based on a predetermined threshold, a fit probability of a good fit, or a reason of a bad fit.

18. The method of claim 17, wherein determining the fit information further comprises:
generating an aggregated fit prediction according to all of the selected rules and criteria, wherein the aggregated fit prediction is generated based on at least one of: a fit combination function, a factor related to a prescription, or a weight of the factor during fit prediction aggregation.

19. The method of claim 12, further comprising generating or updating fit rules and criteria for assessing a fit quality of a head device data pair, based on:
performing an evaluation of fit predictions previously generated;
generating or updating at least one fit rule based on at least one of: the evaluation of fit predictions, real head data, or design data of the wearable device; and
generating or updating at least one fit criterion based on at least one of: the at least one fit rule, the evaluation of fit predictions, real head data, or design data of the wearable device, wherein the at least one fit rule and the at least one fit criterion are stored in a fit rule database.

20. The method of claim 12, further comprising:
obtaining a plurality of captures from each of three different views, wherein each of the plurality of captures includes a two-dimensional (2D) image and a corresponding 3D depth map of a head of a subject;
registering each 2D image to determine displacements due to motion during capturing;
detecting a set of 2D landmark locations on each 2D image;
aggregating the 2D landmark locations across the plurality of captures to generate a set of aggregated 2D landmark locations for each view based on the displacements;
aggregating the 3D depth maps across the plurality of captures to generate an aggregated 3D depth map for each view;
localizing the predetermined head landmarks in 3D space based on the set of aggregated 2D landmark locations and the aggregated 3D depth map for each view;
combining the aggregated 3D depth maps for the three different views into a single depth map;
determining landmark coordinates based on the single depth map;
calculating head data based on the landmark coordinates; and
storing the head data into a real head database.

21. The method of claim 12, wherein the wearable device is one of: a pair of spectacles, a pair of eyeglasses, a pair of sunglasses, a pair of contact lenses, a pair of safety glasses, a pair of swimming goggles, a pair of virtual reality (VR) goggles, a helmet, or a VR helmet.

22. The method of claim 12, wherein the wearable device is spectacles, eyeglasses, sunglasses, contact lenses, smart glasses, safety glasses, swimming goggles, virtual reality (VR) glasses, augmented reality (AR) glasses, a helmet, a VR helmet, AR glasses, or a combination thereof.

23. The system of claim 12, wherein the one or more customers are potential customers, actual customers, or a combination thereof.

24. A non-transitory computer readable medium having computer-executable instructions embodied thereon for predicting a fit quality between a wearable device and one or more potential customers, wherein, when executed by a processor, the computer-executable instructions cause the processor to perform:
receiving a request from a user;
generating, based on the request, simulated head data based on real head data of a sample of the potential customers; and
determining fit information between the simulated head data and at least one design of the wearable device, wherein the fit information is displayed to the user as a response to the request.

25. The non-transitory computer readable medium of claim 24, wherein the request includes information related to at least one of:
a target customer population with predetermined demographic data; or
a proposed set of wearable device designs each of which includes respective size and shape data of the wearable device.

26. The non-transitory computer readable medium of claim 25, wherein the request is related to at least one of:
seeking, among the target customer population, a subset of population having a fit probability larger or smaller than a predetermined threshold based on the proposed set of wearable device designs;
seeking, among the proposed set of wearable device designs, a subset of designs having a fit probability larger or smaller than a predetermined threshold based on the target customer population; or
determining fit information between the proposed set of wearable device designs and the target customer population.

27. The non-transitory computer readable medium of claim 24, wherein the computer-executable instructions further cause the processor to perform:
generating user input data based on the request;
generating queries and configurations based on the user input data;
generating at least one visualized response based on at least one of: the queries, the configurations, or fit results generated based on the user input data; and
providing the at least one visualized response to the user.

28. The non-transitory computer readable medium of claim 27, wherein generating the simulated head data comprises:
determining, based on the user input data, a representation type when sampling population data;
generating a head data sample based on: a real head database, a demographic database associated with the real head database, and the representation type;
determining, based on the user input data, population features interesting to the user;
generating the simulated head data based on the head data sample and the population features, wherein the simulated head data are stored into a simulated head database.

29. The non-transitory computer readable medium of claim 28, wherein determining the fit information comprises:
retrieving and analyzing head data from the simulated head database based on the user input data;
retrieving and analyzing device design data from a wearable device database based on the user input data;
pairing the retrieved head data and the retrieved device design data to generate a sequence of data pairs;
selecting rules and criteria from a fit rule database based on the user input data; and
assessing the sequence of data pairs, based on each of the selected rules and criteria, to generate a fit prediction for each data pair, wherein the fit prediction includes information related to at least one of: an indication of a good fit or bad fit based on a predetermined threshold, a fit probability of a good fit, or a reason of a bad fit.

30. The non-transitory computer readable medium of claim 29, wherein determining the fit information further comprises:
generating an aggregated fit prediction according to all of the selected rules and criteria, wherein the aggregated fit prediction is generated based on at least one of: a fit combination function, a factor related to a prescription, or a weight of the factor during fit prediction aggregation.

31. The non-transitory computer readable medium of claim 24, wherein the computer-executable instructions further cause the processor to perform:
performing an evaluation of fit predictions previously generated;
generating or updating at least one fit rule based on at least one of: the evaluation of fit predictions, real head data, or design data of the wearable device; and
generating or updating at least one fit criterion based on at least one of: the at least one fit rule, the evaluation of fit predictions, real head data, or design data of the wearable device, wherein the at least one fit rule and the at least one fit criterion are stored in a fit rule database.

32. The non-transitory computer readable medium of claim 24, wherein the computer-executable instructions further cause the processor to perform:
obtaining a plurality of captures from each of three different views, wherein each of the plurality of captures includes a two-dimensional (2D) image and a corresponding 3D depth map of a head of a subject;
registering each 2D image to determine displacements due to motion during capturing;
detecting a set of 2D landmark locations on each 2D image;
aggregating the 2D landmark locations across the plurality of captures to generate a set of aggregated 2D landmark locations for each view based on the displacements;
aggregating the 3D depth maps across the plurality of captures to generate an aggregated 3D depth map for each view;
localizing the predetermined head landmarks in 3D space based on the set of aggregated 2D landmark locations and the aggregated 3D depth map for each view;
combining the aggregated 3D depth maps for the three different views into a single depth map;
determining landmark coordinates based on the single depth map;
calculating head data based on the landmark coordinates; and
storing the head data into a real head database.

33. The non-transitory computer readable medium of claim 24, wherein the wearable device is spectacles, eyeglasses, sunglasses, contact lenses, smart glasses, safety glasses, swimming goggles, virtual reality (VR) glasses, augmented reality (AR) glasses, a helmet, a VR helmet, AR glasses, or a combination thereof.

34. The non-transitory computer readable medium of claim 24, wherein the one or more customers are potential customers, actual customers, or a combination thereof.
